(19) United States
(12) Patent Application Publication
(10) Pub. No.: US 2024/0303738 A1
(43) Pub. Date: Sep. 12, 2024

(54) METHODS AND SYSTEMS FOR FACILITATING ANALYSIS OF A MARKET TREND OF INVESTMENT PORTFOLIOS

(71) Applicant: Thomas KODAIR, Sacramento, CA (US)

(72) Inventor: Thomas KODAIR, Sacramento, CA (US)

(21) Appl. No.: 18/180,614

(22) Filed: Mar. 8, 2023

(51) Int. Cl. G06Q 40/06; G06Q 40/04

(52) U.S. Cl. CPC G06Q 40/06; G06Q 40/04

(57) ABSTRACT

The method includes aggregating historic investment data corresponding to multiple financial assets and calculating performance return percentages with reference to the latest investment quote, at each period. The method includes facilitating generation of a visual representation including contour areas indicating a variation of performance-range zones for the multiple financial assets and financial asset lines indicating change in the rank of the multiple financial assets with time. The method includes triggering a buying, selling, or exchanging action of a financial asset among the plurality of financial assets when a mouse corresponding to the pointer is clicked by a user, the pointer hovering over the financial asset line of the financial asset on the visual representation to perform the triggered action.

### TECHNICAL FIELD

The present disclosure relates to a field of complex data analysis and management and, more particularly to methods and systems for facilitating analysis of a market trend of investment portfolios.

### BACKGROUND

An investment portfolio is a collection of financial assets such as stocks, bonds, mutual funds, exchange-traded funds, ticker symbols, etc. Entities such as individual investors, financial professionals, banks, and other financial institutions can have investment portfolios. The investment portfolios can be created by considering the investor's risk tolerance, time frame, and investment objectives, however, creating one manually, is a challenging task for people who are new to the investment environment. Thus, people need assistance in creating investment portfolios.

Traditionally, people take assistance from a professional such as a portfolio manager which refers to investing in active funds. However, people may be bad at predicting the market because the future is unpredictable. Thus, upon the occurrence of unforeseen events such as Global politics, wars, pandemics, etc., the investor may experience a loss by investing in an asset suggested by the portfolio manager. Along with this, for investing in active funds, people are paying service charges to the portfolio managers while experiencing profit as well as loss which is undesirable as the expense ratio is quite a bit higher and may keep increasing.

Alternatively, people can go for investing in passive funds in which an existing market index such as Standard and Poor's (S and P's)—500 is tracked for reflecting its behavior in the passive funds. Thus, there are more chances for the investors to experience profit and there is no expense ratio involved. However, as the future is unpredictable, the occurrence of unforeseen events can still cause investors to experience loss. There exist multiple computer-implemented approaches implemented to assist people to create an investment portfolio and start to make investments.

One approach includes using an automated investing service (robo-advisor) that uses computer algorithms and advanced software to build and manage investment portfolios. However, such an approach is less reliable and less efficient because it has limited flexibility and may not be personalized to a particular user.

Another approach includes the usage of investment dashboards as digital tools, which are usually available as a website or an application for tracking and managing investments based on analysis of historic investment data. Examples of investment dashboards include a Financial Reporting Dashboard, Cash Flow Valuation Dashboard, Digital Marketing Dashboard, and the like. However, in such an approach, results such as performance, ranking, investment volatility, and the like are plotted separately on separate charts, and hence may have to be compared manually for different values, thereby making the approach complex to analyze, time-consuming, and less efficient. Further,

Further, when coordinate parallel charts may be used for plotting the above-mentioned results, additional hidden steps are required to be implemented to eliminate noise and provide clear full resolution, and usable functionality. Furthermore, histograms in many chart-generating websites only provide a comparison to the last close day and one time period.

Thus, a technological need exists for improved methods and systems for facilitating analysis of a market trend of investment portfolios.

### SUMMARY

Various embodiments of the present disclosure provide methods and systems for facilitating analysis of a market trend of investment portfolios.

In an embodiment, a computer-implemented method is disclosed. The computer-implemented method includes. The computer-implemented method includes aggregating historic investment data corresponding to a plurality of financial assets that are traded in a predefined investment market. The historic investment data include a plurality of investment quotes for each of the plurality of financial assets at a plurality of subsequent periods. The computer-implemented method further includes calculating a performance return percentage with reference to a corresponding latest investment quote of the plurality of investment quotes of each financial asset of the plurality of financial assets, at each period of the plurality of subsequent periods. Further, the computer-implemented method includes affixing a baseline for a market performance index by subtracting a baseline performance return percentage corresponding to a baseline financial asset, from the performance return percentage of each financial asset at each period. The computer-implemented method further includes generating a sorted list of performance return percentages by sorting values corresponding to the performance return percentage for each financial asset within each period in a predefined order. The computer-implemented method includes determining a position of each of the plurality of financial assets within each period by allocating a rank to each investment quote within the corresponding period, based at least on, the sorted list of performance return percentages. The computer-implemented method also includes facilitating generation of a visual representation for analyzing a market trend of the plurality of financial assets, based, at least on, the affixed baseline for the market performance index. The visual representation includes contour areas indicating a variation of one or more performance-range zones for the plurality of financial assets with time, financial asset lines indicating a change in the rank of the plurality of financial assets with time, and a baseline curve corresponding to the affixed baseline.

In another embodiment, a server system is disclosed. The server system includes a communication interface and a memory including executable instructions. The server system also includes a processor communicably coupled to the memory. The processor is configured to execute the instructions to cause the server system, at least in part, to aggregate historic investment data corresponding to a plurality of financial assets that are traded in a predefined investment market, the historic investment data including a plurality of investment quotes for each of the plurality of financial assets at a plurality of subsequent periods. The server system is further caused to calculate a performance return percentage with reference to a corresponding latest investment quote of the plurality of investment quotes of each financial asset of the plurality of financial assets, at each period of the plurality of subsequent periods. Furthermore, the server system is caused to affix a baseline for a market performance index by subtracting a baseline performance return percentage corresponding to a baseline financial asset, from the performance return percentage of each financial asset at each period. Moreover, the server system is caused to generate a sorted list of performance return percentages by sorting values corresponding to the performance return percentage for each financial asset within each period in a predefined order. Further, the server system is caused to determine a position of each of the plurality of financial assets within each period by allocating a rank to each investment quote within the corresponding period, based at least on, the sorted list of performance return percentages. Further, the server system is caused to facilitate generation of a visual representation for analyzing a market trend of the plurality of financial assets, based, at least on, the affixed baseline for the market performance index. The visual representation includes contour areas indicating a variation of one or more performance-range zones for the plurality of financial assets with time, financial asset lines indicating a change in the rank of the plurality of financial assets with time, and a baseline curve corresponding to the affixed baseline.

### BRIEF DESCRIPTION OF THE FIGURES

For a more complete understanding of example embodiments of the present technology, reference is now made to the following descriptions taken in connection with the accompanying drawings in which:

FIG. 1 illustrates an example representation of an environment related to at least some example embodiments of the present disclosure;

FIG. 2 illustrates a simplified block diagram of a server system, in accordance with an embodiment of the present disclosure;

FIG. 3A illustrates a detailed block diagram of the server system facilitating analysis of a market trend of example investment portfolios, in accordance with an embodiment of the present disclosure;

FIG. 3B is a tabular representation of an example set of historic investment data aggregated by the server system via an aggregator, in accordance with an embodiment of the present disclosure;

FIG. 3C is a tabular representation of performance return percentages calculated for the example set of the historic investment data presented in FIG. 3B by the server system via a performance return percentage calculation module, in accordance with an embodiment of the present disclosure;

FIG. 3D is a tabular representation of a sorted list of performance return percentages showing a pattern indicating variation in the performance return percentages with time and a baseline being a variation of a performance return percentage corresponding to a dollar (US$) 1 with time, in accordance with an embodiment of the present disclosure;

FIG. 3E is a tabular representation indicating ranks allocated to symbols enlisted in FIG. 3B, based on the sorted list of the performance return percentages, in accordance with an embodiment of the present disclosure;

FIG. 3F is a user interface (UI) displaying a chart that assists a user is analyzing the market trend of the example investment portfolios that are traded in a predefined investment market, in accordance with an embodiment of the present disclosure;

FIG. 4A is a tabular representation of performance return percentages calculated for the example set of the historic investment data presented in FIG. 3B, highlighting a baseline that is shifted from the variation of a performance return percentage corresponding to a US$1 with time to a variation of a performance return percentage for a preferred index symbol, in accordance with an embodiment of the present disclosure;

FIG. 4B is a tabular representation of the performance return percentages calculated for the example set of the historic investment data presented in FIG. 3B, after performing the step of shifting the baseline, in accordance with an embodiment of the present disclosure;

FIG. 4C is a tabular representation of a sorted list of performance return percentages showing a pattern indicating variation in the performance return percentages with time of FIG. 4B, in accordance with an embodiment of the present disclosure;

FIG. 4D is a tabular representation indicating ranks allocated to symbols enlisted in FIG. 4A, based on the sorted list of the performance return percentages of FIG. 4C, in accordance with an embodiment of the present disclosure;

FIG. 5 is a visual representation indicating a pattern associated with the variation in the sorted list of the performance return percentages with time, having two inflection points A and B, in accordance with an embodiment of the present disclosure;

FIG. 6A is a visual representation indicating a canvas background associated with the variation in the sorted list of the performance return percentages with time and a pattern of stock lines, in accordance with an embodiment of the present disclosure;

FIG. 6B is a visual representation indicating a canvas background associated with the variation in the sorted list of the performance return percentages with time and a pattern of stock lines, in accordance with another embodiment of the present disclosure;

FIGS. 7A-7E collectively represents a live behavior of the investment portfolios with time represented in different visual representations, in accordance with an embodiment of the present disclosure;

FIG. 8 is a flowchart illustrating a computer-implemented method for analyzing a market trend of investment portfolios, in accordance with an embodiment of the present disclosure; and

FIG. 9 is a simplified block diagram of an electronic device, in accordance with an embodiment of the present disclosure.

The drawings referred to in this description are not to be understood as being drawn to scale except if specifically noted, and such drawings are only of example in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification is not necessarily all refer to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “investment” may have been used throughout the description, this term generally refers to an action or process of investing money to purchase an asset to attain an increase in value over a period of time.

The terms “asset”, “financial asset”, “financial instrument”, and “security” may have been used interchangeably throughout the description, and unless the context suggests otherwise, these terms generally refer to an investment asset or a monetary contract between two parties whose value is derived from a contractual claim of what they represent and can be traded and settled.

The terms “investment portfolio” and “portfolio” may have been used interchangeably throughout the description, and unless the context suggests otherwise, these terms generally refer to a collection of financial assets such as stocks, bonds, mutual funds, exchange-traded funds, ticker symbols, etc.

The terms “stock market”, “investment market”, and “market” may have been used interchangeably throughout the description, and unless the context suggests otherwise, these terms generally refer to an aggregation of buyers and sellers of stocks, which represent ownership claims on businesses.

The terms “market trend” and “trend” may have been used interchangeably throughout the description, and unless the context suggests otherwise, these terms generally refer to an overall direction of a market or an asset's price. Technical analysis of investments or investment portfolios uses trendlines or price action to identify trends, that highlight when the price is making higher swing highs and higher swing lows for an uptrend, or lower swing lows and lower swing highs for a downtrend.

The terms “trendlines”, “stock lines”, and “lines” may have been used interchangeably throughout the description, and unless the context suggests otherwise, these terms generally refer to easily recognizable lines that traders draw on charts to connect a series of prices together, show some data's best fit, or continuous rank values allocated to an asset at different periods.

The term “investor” may have been used throughout the description, and this term generally refers to a person or organization that puts money into financial schemes, property, etc. with the expectation of achieving a profit.

The terms “stock quotes”, “quotes”, “stock quotations”, “quotations”, “investment quotes”, and “investment quotations” may have been used interchangeably throughout the description, and unless the context suggests otherwise, these terms generally refer to a price of a stock or a financial asset as quoted on an exchange in the investment market.

The terms “market investments performance”, “investment portfolio performance”, “investment portfolio performance return”, “portfolio performance”, and “portfolio performance return” may have been used throughout the description, and these terms generally refer to an approximate measure of an investment's profitability.

The term “contour” may have been used throughout the description, and this term generally refers to an outline representing or bounding the shape or form of something.

The terms “contour canvas”, “topographical maps”, “contour topological maps”, “chart” and “contour area background chart” may have been used interchangeably throughout the description, and these terms generally refer to a three-dimensional chart or graph having contour lines or contour areas plotted that is a function of two variables such as a performance return percentage of each financial asset in the market and time. The function of the two variables has the same particular value.

The term “anchor(s)” may have been used throughout the description, and this term generally refers to a set point of a threshold set upon crossing of which a notification may be triggered.

The terms “investment volatility” and “volatility” may have been used interchangeably throughout the description, and these terms generally refer to a rate at which the price of a stock increases or decreases over a particular period.

The terms “individual stock correlation” and “stock correlation” may have been used interchangeably throughout the description, and unless the context suggests otherwise, these terms generally refer to the relationship that exists between two stocks and respective price movements.

The terms “market liquidity”, and “stock liquidity” may have been used interchangeably throughout the description, and unless the context suggests otherwise, these terms generally refer to how rapidly shares of a stock can be bought or sold without substantially impacting the stock price.

### OVERVIEW

Various embodiments of the present disclosure provide methods and systems for facilitating analysis of a market trend of investment portfolios. The system facilitates a generation of a visual representation such as a contour area background chart which assists a user willing to enter an investment market or already a part of the investment market in having a depth and a continuous analysis of the market trend of various investment portfolios, investments, stocks, symbols, and the like that participated in the investment market. The chart simplifies portfolio management of an investor entity (also termed as the “user”), as the chart facilitates the user to visually compare performance returns of multiple financial assets and ranking relative to the total market in one chart. The chart also facilitates the user to visually detect a depth of market transitions when trending upward, trending downward, and positioning anchors to trigger measurable events. The chart further facilitates the user to discover investment volatility and trends relative to the rest of the market.

In one embodiment, the disclosed system may be embodied as a platform or a mobile application such as, but not limited to, a portfolio market trend analysis platform. The term “portfolio market trend analysis platform” refers to a platform or an application that facilitates aggregating historic investment data, calculating performance return and ranking of the multiple financial assets that are traded in the market, and generating a visual representation for analyzing multiple statistical aspects corresponding to financial investments. The system uses a chart generation mechanism for generating the visual representation indicating variation in multiple parameters onto a single chart. For instance, this is possible because the visual representation generated by the system resembles topographical maps having a valley, a summit, and a baseline. Further, as used herein, the term “chart generation mechanism” refers to a mechanism upon implementation that enables converting data into visual representations such as charts.

Further, for the user to be able to use the system, the user may have to register with the system. In an instance, the user may be an investor, a trader, a buyer, or a seller who is either new to investment marketing or a professional willing to grow in value by improving the investment portfolio of the user. Thus, the system facilitates the user to register with the system by providing personal details via a user device, when the user installs the application on the user device. Upon registration, the user may be able to use the features of the system and understand the current behavior of the market.

Further, for the system to be able to provide the visual representation indicating a current behavior of the market, the system may receive quotes of trade prices corresponding to multiple financial assets such as stocks at multiple continuous periods. For example, the multiple continuous periods may be every consecutive year for the past ten years. So, prices of the multiple assets during each year for the past ten years are received by the system. The system calculates performance return percentages for each asset during each year for the past ten years with reference to a latest quote. The system further chooses a baseline and sorts the performance return percentages in a predefined order. The predefined order may be a minimum negative value to a maximum positive value. The quotes received may be arranged in a tabular format, and thus a sorted list of performance return percentages may be a two-dimensional (2-D) array, again arranged in the tabular format.

In an embodiment, each value in the sorted list of performance return percentages is allocated with a predefined color with a predefined shade intensity. The predefined shade intensity is dependent on how far each value is from a baseline value (0 percent (%)) in the sorted list of performance return percentages. Furthermore, the system determines a position of each asset for each period by assigning a rank to each asset based on the sorted list of performance return percentages. Moreover, the system plots the values corresponding to the performance return percentages on a chart having X-axis representing ‘time’, Y-axis representing ‘rank’, and Z-axis representing values corresponding to ‘performance return percentages’. The values may be plotted based at least on the rank assigned to the values in the sorted list of performance return percentages. Upon generating the chart, the system applies additional features to the chart, the additional features including setting up a refresh timer to stream market updates, setting up an interactive pointer to hover on the chart for displaying chart-related information, and setting up anchors for notifications.

Moreover, the chart resembles a topographical map having a valley, a baseline, and a summit, and hence is facilitating the plotting of multiple parameters such as performance return percentages and rank on a single chart. Further, the application of the additional features to the chart, as mentioned above, enables the user to visually spot a stock line for a preferred stock and observe a trend of the stock line with time along with a price value of the preferred stock at each period by merely hovering a pointer on the chart. Further, the performance return and rank of the preferred stock can be compared with other stocks in the market for each period, as all the stocks for a particular time period are plotted on the chart. In addition, other parameters such as investment volatility, individual stock correlation, market liquidity, and the like may also be determined by the system and presented on the chart, based at least on the observations obtained from the chart plotted for the performance return percentages and ranks. Further, upon clicking on the stock lines that appear on the chart upon hovering over the chart with a pointer, stocks corresponding to the selected stock lines can be purchased or sold based on a position (open or close/long or short) associated with the stocks.

Further, various embodiments of the present disclosure offer multiple advantages and technical effects. For instance, the system provides a single chart that enables a discovery of any trending stock in a predefined investment market, by merely hovering a pointer over the chart without clicking on the chart. Upon hovering the pointer, the system performs a simple lookup in pre-stored tables having stock prices, determines and shows stock lines corresponding to the stock prices underneath the pointer without even clicking on the chart with the pointer. Alternatively, upon hovering the pointer over a portfolio list or a filter list, stock lines underneath the pointer can appear on the chart from anchors set on the chart.

Further, in an instance, the system provides smart anchors or predetermined strategies that enable dynamic optimization of fixed anchors as market conditions change from trending up to trending down and vice versa. Furthermore, the chart generated by the system can be used as a feature engineering step for pattern observability and training any neural network such as artificial neural networks. Moreover, a feature of performance representation in terms of relative percentage, eliminate actual prices and numbers, and the task of remembering the always changing price values. Therefore, all these features provided by the system, make the system more reliable and more efficient, as the chart can be used for live market data, simulation practice, and replay of the latest market actions.

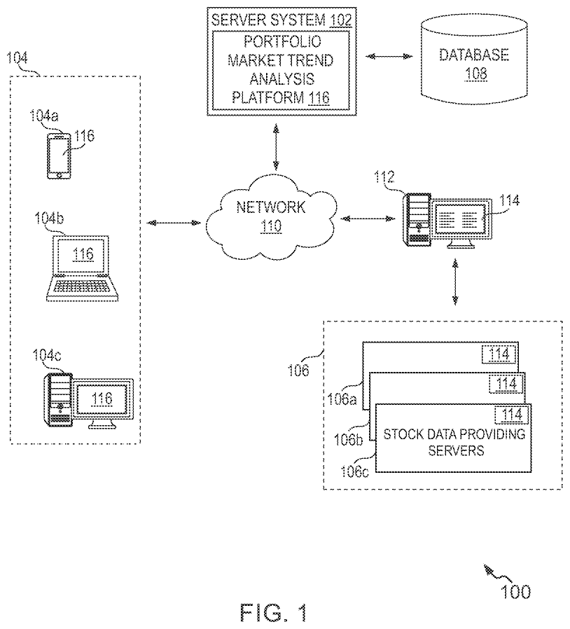

Various example embodiments of the present disclosure are described hereinafter with reference to FIGS. 1 to 9.

FIG. 1 illustrates an example representation of an environment 100 related to at least some example embodiments of the present disclosure. Although the environment 100 is presented in one arrangement, other embodiments may include the parts of the environment 100 (or other parts) arranged otherwise depending on, for example, facilitating analysis of multiple statistical parameters corresponding to analysis of investments and trades associated with the financial assets traded in a predefined investment market. For instance, the financial assets include at least one of stocks, bonds, mutual funds, exchange-traded funds, ticker symbols, and the like. Further, the multiple statistical parameters may include at least one of market trend, quotes, performance return, investment volatility, individual stock correlation, market liquidity, and the like. Furthermore, examples of the predefined investment market may include one of a stock market, a bond market, a commodities market, a capital market, a money market, a primary market, a secondary market, and the like. The predefined investment market may provide a platform for the users for performing trading of the financial assets or invest in the financial assets for short term or long term based on market behavior of the predefined investment market.

The example representation of the environment 100 as depicted in FIG. 1 includes a server system 102, a plurality of user devices 104a, 104b, and 104c (also referred to as user devices 104) associated with a plurality of users (also referred to as users), one or more stock data providing servers 106a, 106b, and 106c (also referred to as stock data providing servers 106) associated with one or more stock data providers (also referred to as stock data providers), and a database 108 connected to, and in communication with (and/or with access to) a wireless communication network (e.g., a network 110). The environment 100 further depicts a data provider device 112 that fetches historic investment data from the one or more stock data providing servers 106 and transmits to the server system 102 via the network 110. Moreover, the historic investment data is stored and managed in the one or more stock data providing servers 106 by the one or more stock data providers via the data provider device 112 upon installing a third-party data management application 114 on the data provider device 112.

In an embodiment, the server system 102 is deployed as a standalone server or can be implemented in cloud as software as a service (SaaS). The server system 102 provides or hosts a portfolio market trend analysis platform 116 (also termed as a portfolio market trend analysis application 116) for facilitating aggregation of the historic investment data, calculating performance return percentages, ranking the financial assets that are traded in the predefined investment market, and generating a visual representation for analyzing the multiple statistical parameters corresponding to the investments associated with the financial assets. An instance of the portfolio market trend analysis platform 116 is also accessible to the user devices 104 as shown in the environment 100 in FIG. 1. This is enabled by installing the portfolio market trend analysis platform 116 on the user devices 104, which enables the users to be able to access the server system 102 on the user devices 104.

For instance, the user devices 104 may include any suitable electronic or computing devices such as a smartphone, a personal computer, a laptop, a personal digital assistant (PDA), an electronic tablet, a desktop computer, a wearable device, a smart device such as smart TV or smart appliance, a smartwatch, etc., among other suitable electronic devices. Further, the users may be any individual, an organization, a representative of a corporate entity, a non-profit organization, a company, a bank, an insurance company, an educational institution, and the like. For instance, the users may be buyers and sellers of the financial assets, investors, stockbrokers, traders, dealers, and the like. Thus, the users may include any person or entity such as an organization that is either willing to start to make investments in the predefined investment market or already a member of the predefined investment market who is willing to analyze a market trend of multiple investment portfolios to predict futuristic behavior of the predefined investment market.

Further, for instance, the stock data providers correspond to multiple application programming interfaces (APIs) that provide access to various data sets from different companies. The data sets may include information about asset prices, stock prices, volume, and other details as and when generated on multiple investment market platforms where multiple financial assets exchange is carried out between multiple users. For example, the APIs include social media platforms, stock news platforms, stock data-extracting-specialized platforms, etc. The APIs may be associated with the stock data providing servers 106 that store the historic investment data such as the data sets extracted by the APIs.

In an embodiment, the stock data providing servers 106 are deployed as standalone servers or can be implemented in cloud as SaaS. The stock data providing servers 106 provide or host the third-party data management application 114 for facilitating the management of the historic investment data in the stock data providing servers 106, fetching the historic investment data from the stock data providing servers 106 and transmitting the historic investment data to the server system 102. Further, an instance of the third-party data management application 114 is also accessible to the data provider device 112 as shown in the environment 100 in FIG. 1. This is enabled by installing the third-party data management application 114 on the data provider device 112, which enables admins or owners of the third-party data management application 114 to be able to access the stock data providing servers 106 via the APIs on the data provider device 112.

For instance, the data provider device 112 may include any suitable electronic or computing devices such as a smartphone, a personal computer, a laptop, a personal digital assistant (PDA), an electronic tablet, a desktop computer, a wearable device, a smart device such as smart TV or smart appliance, a smartwatch, etc., among other suitable electronic devices.

Furthermore, the database 108 may be adapted to store basic information, such as, but not limited to, personal details of the users, the historic investment data upon fetching from the stock data providing servers 106, and the like.

Various entities in the environment 100 may connect to the network 110 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, future communication protocols or any combination thereof. For example, the network 110 may include multiple different networks, such as a private network made accessible by the server system 102 and a public network (e.g., the Internet, etc.) through which the server system 102 may communicate.

It should be noted that the number of users, the user devices, the stock data providing servers, the stock data providers, and the data provider devices described herein are only used for exemplary purposes and do not limit the scope of the invention. The main objective of the invention is to provide a platform facilitating analysis of multiple statistical aspects associated with investments corresponding to the financial assets traded in the predefined investment market.

In some embodiments, for a user to be able to use the portfolio market trend analysis platform 116, the user may have to register with the server system 102. Thus, the server system 102 facilitates the user to register by providing personal details of the user via the user device 104a on the portfolio market trend analysis platform 116. The server system 102 receives the personal details, registers the user and creates a user profile associated with a user account on the portfolio market trend analysis platform 116. The personal details may include a name, an email Identity (ID), contact details, education, qualification, learning experience, a field of interest, password, and the like corresponding to the user.

Upon registration, the user may further be able to have access to multiple features facilitated by the portfolio market trend analysis platform 116. In a non-limiting example, the multiple features include generating a chart that is a live interactive visual representation of contour performance changes similar to a topological map, which provide a clear and certain view of the performance behavior of the financial assets traded in the predefined investment market. The multiple features further include a direct access hover pointer to scan, select, and make decisions based on structured criteria. Further, the multiple features also include custom-made anchors to utilize the chart and interact with real market trends and dynamics. The multiple features may further include additional features that may have not been disclosed in the present disclosure, however, the server system 102 may be capable of performing them.

Further, for the server system 102 to be able to perform or facilitate the performing of the multiple features, the server system 102 may be configured to aggregate the historic investment data corresponding to a plurality of financial assets that are traded in the predefined investment market. The historic investment data include a plurality of investment quotes for each of the plurality of financial assets at a plurality of subsequent periods.

In one embodiment, the server system 102 is further configured to calculate a performance return percentage with reference to a corresponding latest investment quote of the plurality of investment quotes of each financial asset of the plurality of financial assets, at each period of the plurality of subsequent periods. In another embodiment, the server system 102 is configured to calculate the performance return percentage with reference to multiple reference points on a time period on the chart, that are strategically placed at time market highs and market lows to provide visibility of each financial asset behavior within uptrend or downtrend. In yet another embodiment, the server system 102 is configured to calculate the performance return percentage with reference to an average of a predefined count of the latest investment quotes of the plurality of investment quotes.

Furthermore, the server system 102 is configured to affix a baseline for market performance index by subtracting a baseline performance return percentage corresponding to a baseline financial asset, from the performance return percentage of each financial asset at each period. Upon affixing the baseline, the server system 102 is further configured to generate a sorted list of performance return percentages by sorting values corresponding to the performance return percentage for each financial asset within each period in a predefined order.

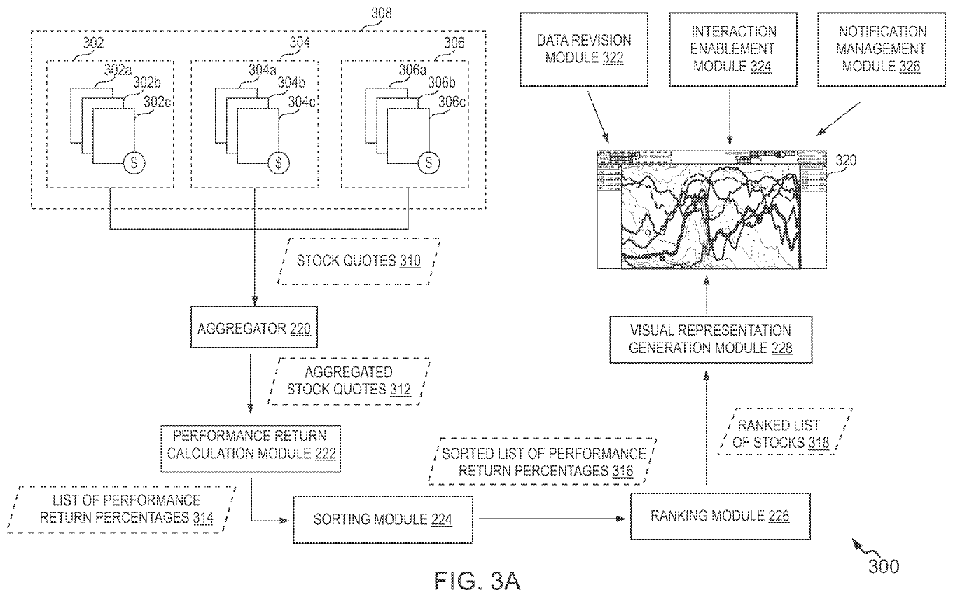

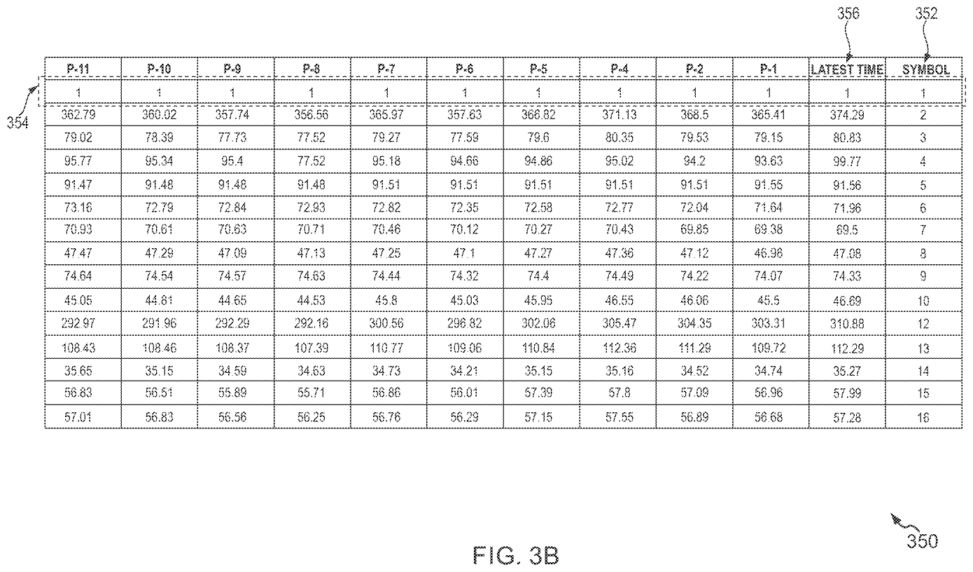

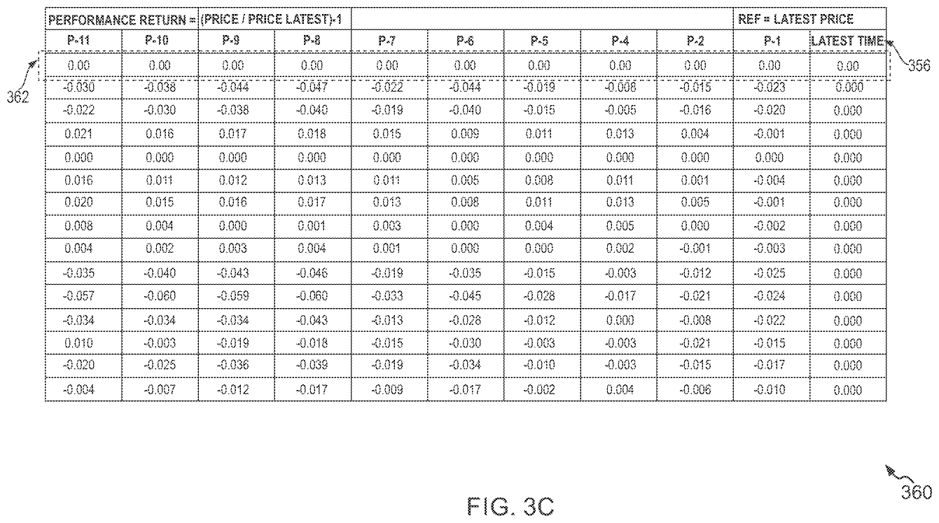

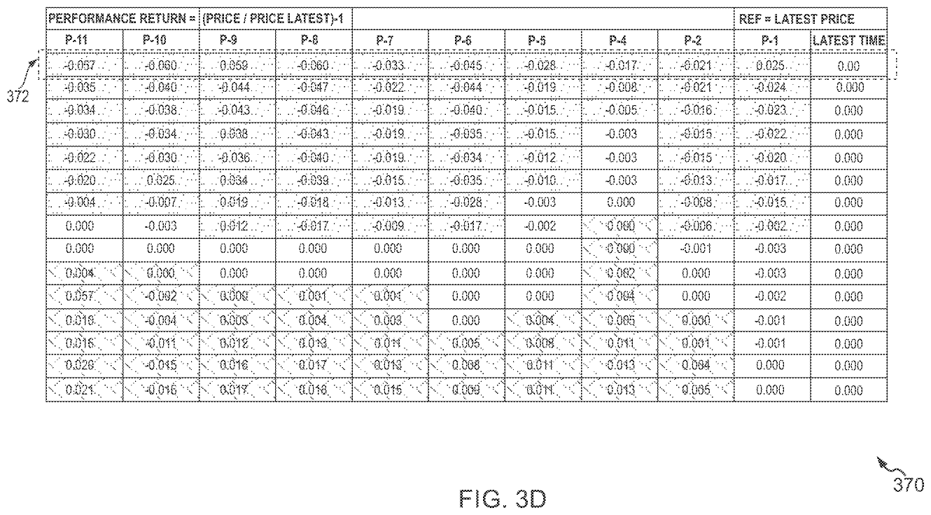

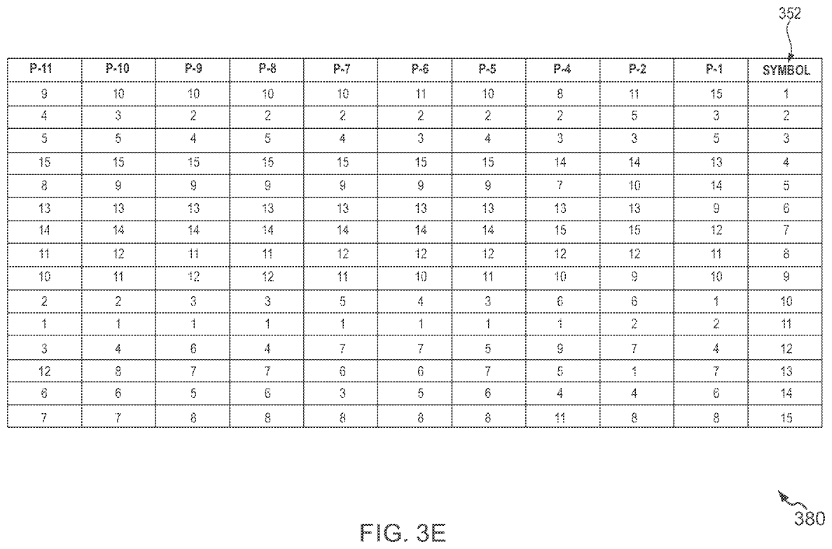

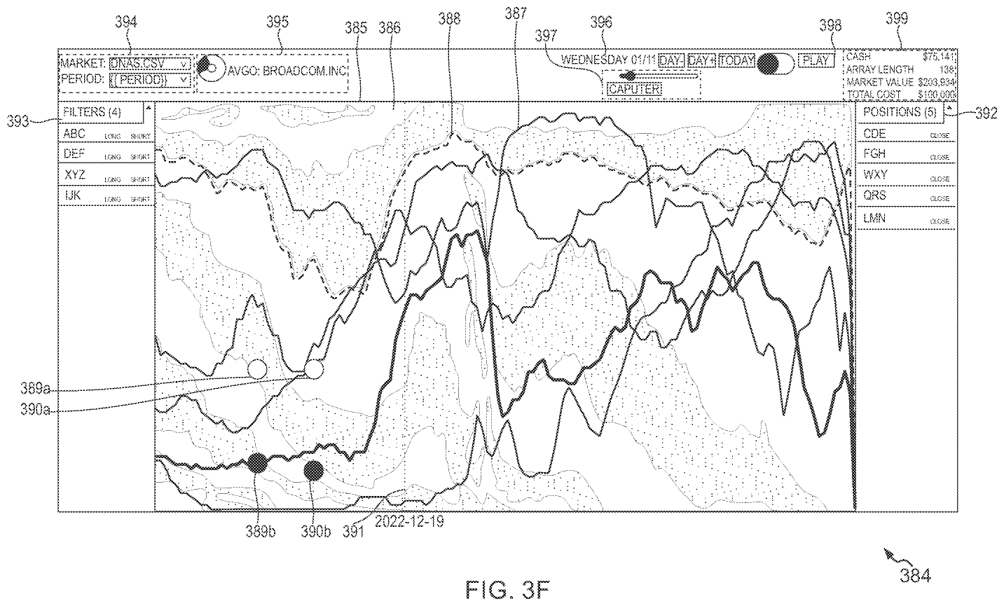

Moreover, the server system 102 is configured to determine a position of each of the plurality of financial assets within each period by allocating a rank to each investment quote within the corresponding period, based at least on, the sorted list of performance return percentages. The server system 102 is further configured to facilitate the generation of a visual representation for analyzing a market trend of the plurality of financial assets, based, at least on, the affixed baseline for the market performance index. The visual representation includes contour areas indicating a variation of one or more performance-range zones for the plurality of financial assets with time, and financial asset lines indicating a change in the rank of the plurality of financial assets with time. Further, a detailed explanation of the configuration of the server system 102 with examples is explained in further parts of the description with references to FIGS. 3A-3FF.

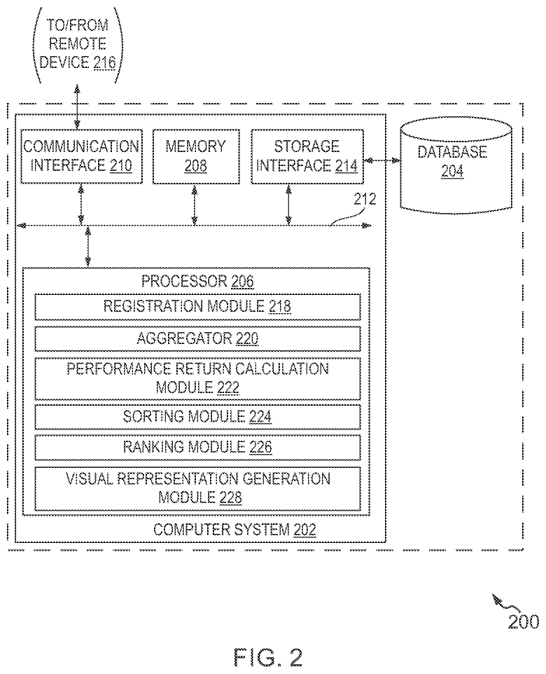

FIG. 2 illustrates a simplified block diagram of a server system 200, in accordance with an embodiment of the present disclosure. For example, the server system 200 is similar to the server system 102 as described in FIG. 1. In some embodiments, the server system 200 is embodied as a standalone physical server and/or has a cloud-based and/or SaaS-based (software as a service) architecture. The server system 200 is configured to facilitate the generation of the visual representation indicating the variation in the performance return percentages corresponding to the plurality of financial assets over continuous time periods. The visual representation is generated upon aggregating the historic investment data, calculating the performance return percentages with respect to a predefined reference value, affixing a baseline, sorting the performance return percentages in the predefined order, and ranking the symbols based, at least on the sorting.

The server system 200 includes a computer system 202 and a database 204. The computer system 202 includes at least one processor, such as a processor 206 for executing instructions, a memory 208, a communication interface 210, a bus 212, and a storage interface 214. The bus 212 enables entities of the computer system 202 to communicate with each other. The database 204 is an example of the database 108 of FIG. 1.

In some embodiments, the database 204 is integrated into the computer system 202. For example, the computer system 202 may include one or more hard disk drives as the database 204. The storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

It is to be noted that although the computer system 202 is depicted to include only one processor, the computer system 202 may include a greater number of processors therein. The processor 206 includes a suitable logic, circuitry, and/or interfaces to execute computer-readable instructions for performing one or more operations for generating the visual representation indicating the variation in the performance return percentages corresponding to the plurality of financial assets over the continuous time periods. Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like.

In an embodiment, the memory 208 is capable of storing the computer-readable instructions. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In another embodiment, the memory 208 may be realized in the form of a database server or cloud storage working in conjunction with the server system 200, without departing from the scope of the present disclosure.

The processor 206 is operatively coupled to the communication interface 210 such that the computer system 202 is capable of communicating with a remote device 216 such as the user devices 104, or with any entity connected to the network 110 (as shown in FIG. 1). In one embodiment, the processor 206 is configured to facilitate installing an instance of the portfolio market trend analysis platform 116 corresponding to the server system 102 on the user devices 104. This enables the implementation of a plurality of functionalities by multiple entities described in the disclosure.

It is to be noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

The processor 206 is depicted to include a registration module 218, an aggregator 220, a performance return calculation module 222, a sorting module 224, a ranking module 226, and a visual representation generation module 228. It should be noted that components, described herein, can be configured in a variety of ways, including electronic circuitries, digital arithmetic and logic blocks, and memory systems in combination with software, firmware, and embedded technologies.

Upon installing the portfolio market trend analysis application 116 on the user device 104a, the server system 200 facilitates the user to register with the portfolio market trend analysis application 116 via the registration module 218. This enables the user to be able to use all the features facilitated by the server system 200. Thus, the registration module 218 is configured to register the user with the portfolio market trend analysis application 116 upon receiving a plurality of personal details via a registration user interface (UI) on the user device 104a.

Further, the aggregator 220 is configured to aggregate the historic investment data corresponding to the plurality of financial assets that are traded in the predefined investment market. The historic investment data includes the plurality of investment quotes for each of the plurality of financial assets at the plurality of subsequent periods.

The performance return calculation module 222 is configured to calculate a performance return percentage with reference to a corresponding latest investment quote of the plurality of investment quotes of each financial asset of the plurality of financial assets, at each period of the plurality of subsequent periods. The performance return calculation module 222 is further configured to affix a baseline for a market performance index by subtracting a baseline performance return percentage corresponding to a baseline financial asset, from the performance return percentage of each financial asset at each period

The sorting module 224 is configured to generate a sorted list of performance return percentages by sorting values corresponding to the performance return percentage for each financial asset within each period in a predefined order.

The ranking module 226 is configured to determine a position of each of the plurality of financial assets within each period by allocating a rank to each investment quote within the corresponding period, based at least on, the sorted list of performance return percentages.

The visual representation generation module 228 is configured to facilitate generation of the visual representation for analyzing a market trend of the plurality of financial assets, based, at least on, the affixed baseline for the market performance index. The visual representation includes contour areas indicating a variation of one or more performance-range zones for the plurality of financial assets with time, and financial asset lines indicating a change in the rank of the plurality of financial assets with time.

Additionally, the server system 200 may further include a data revision module, an interaction enablement module, and a notification management module shown in FIG. 3A. The data revision module is configured to revise the generated visual representation with live data feed and new time periods when the predefined investment market is open for trading, upon receiving the live data feed. Further, the interaction enablement module is configured to facilitate a pointer to interact with the visual representation on a user interface (UI) of the user device 104a having the portfolio market trend analysis application 116 installed, by hovering over the visual representation. Furthermore, the notification management module is configured to generate a notification on the user device 104a based, at least on, one or more anchors set on the visual representation, the one or more anchors associated with predefined criteria.

FIG. 3A illustrates a detailed block diagram 300 of the server system 102 facilitating analysis of the market trend of example investment portfolios, in accordance with an embodiment of the present disclosure. The example investment portfolios may include investment portfolios 302, 304, and 306. Each investment portfolio 302-306 may be associated with the users respectively that participated in the predefined investment market such as a stock market 308. Moreover, each investment portfolio 302-306 may include multiple financial assets. For example, the investment portfolio 302 may include the financial assets such as a stock 302a, 302b, and 302c, the investment portfolio 304 may include the financial assets such as a stock 304a, 304b, and 304c, and the investment portfolio 306 may include the financial assets such as a stock 306a, 306b, and 306c.

The server system 102 is configured to receive stock quotes 310 corresponding to the stocks 302a-302c. 304a-304c, and 306a-306c (also termed as symbols 302a-302c, 304a-304c, and 306a-306c). The aggregator 220 of the server system 102 aggregates the stock quotes 310 that are extracted from the multiple stock data providing servers 106a-106c, for the server system 102 to be able to receive the stock quotes 310. The stock quotes 310 are a part of the historic investment data that are aggregated and arranged in a tabular representation, via the aggregator 220, as shown in FIG. 3B. Thus, the aggregator 220 may create aggregated stock quotes 312 including an (X, Y) matrix array with each row indicating the stock quotes 310 for each symbol of the example investment portfolios and each column indicating the stock quotes 310 for each period for a predefined time interval. The predefined time interval may include the past five years, past ten years, past twelve years, or the like. Further, the server system 102 may store the aggregated stock quotes 312 in the database 108 in the form of the (X, Y) matrix array. Moreover, the aggregator 220 may receive, aggregate, and arrange additional stock quotes as shown in FIG. 3B, other than the stock quotes 312, and hence the aggregated stock quotes 312 may be updated in the database 108. Thus, in an instance, the historic investment data include the stock quotes 312 and the additional stock quotes.

Furthermore, the performance return calculation module 222 is configured to fetch the (X, Y) matrix array of the aggregated stock quotes 312. The performance return calculation module 222 further calculates the performance return percentage with reference to a predefined reference threshold of each symbol (e.g., symbols 302a-302c, 304a-304c, and 306a-306c), at each period P-1 to P-11 and the latest time period. However, FIGS. 3C and 3D show values of the performance return percentages that are normalized with respect to unity. In one embodiment, the predefined reference threshold includes a latest stock quote for each symbol. In another embodiment, the predefined reference threshold includes multiple reference quotes during the period of the past twelve years based on market highs and market lows. In yet another embodiment the predefined reference threshold includes an average of a predefined count of the latest stock quotes. The term “latest stock quote” is indicated in FIGS. 3A-3D as ‘latest price’ and ‘price latest’. An instance of the embodiment, when the predefined reference threshold includes the latest stock quote for each symbol is explained in detail in further parts of the description with reference to FIGS. 3B-3F.

Upon calculating the performance return percentages for each symbol for each period, a list of performance return percentages 314 generated by the performance return calculation module 222 is stored in the database 108. Further, analyzing whether the market trend of the stocks 302, 304, and 306 owned by the users 104 is moving upward or downward, or if the market trend is getting better or worse is essential, for the users 104 to be able to decide whether to keep the stock open for sale or close, or whether to purchase stocks that are open or no, and the like. Therefore, either before sorting or after sorting the list of performance return percentages, a baseline for the market performance index may have to be affixed with which market behavior of all the stocks traded in the market can be compared for identifying the market trend of the performance of the stocks. Thus, the server system 102 is configured to affix the baseline for the market performance index by subtracting a baseline performance return percentage corresponding to a baseline financial asset, from the performance return percentage of each financial asset at each period.

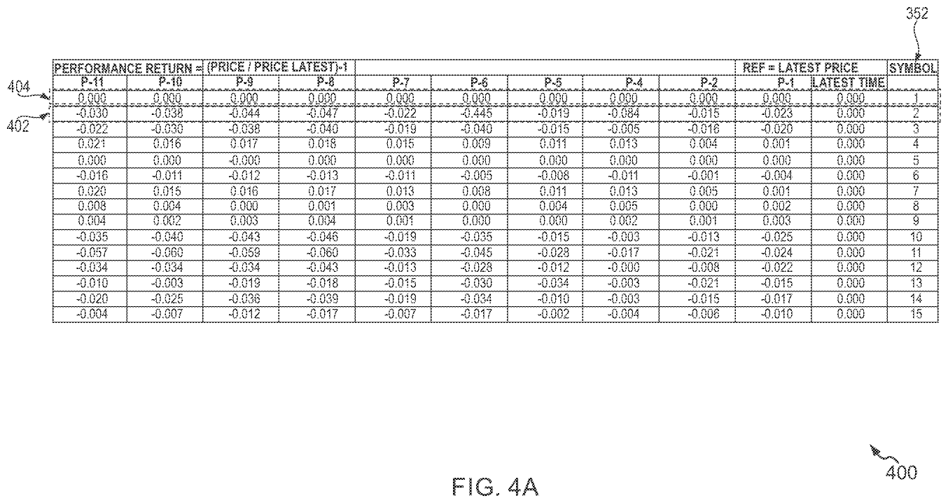

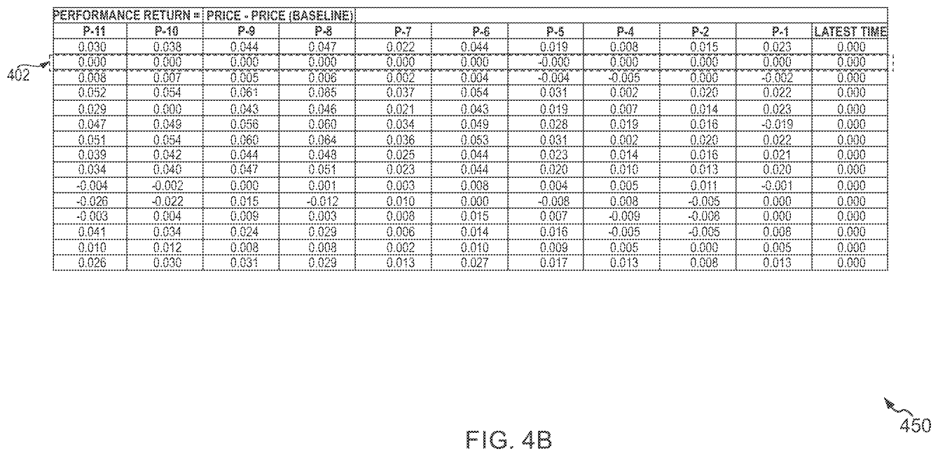

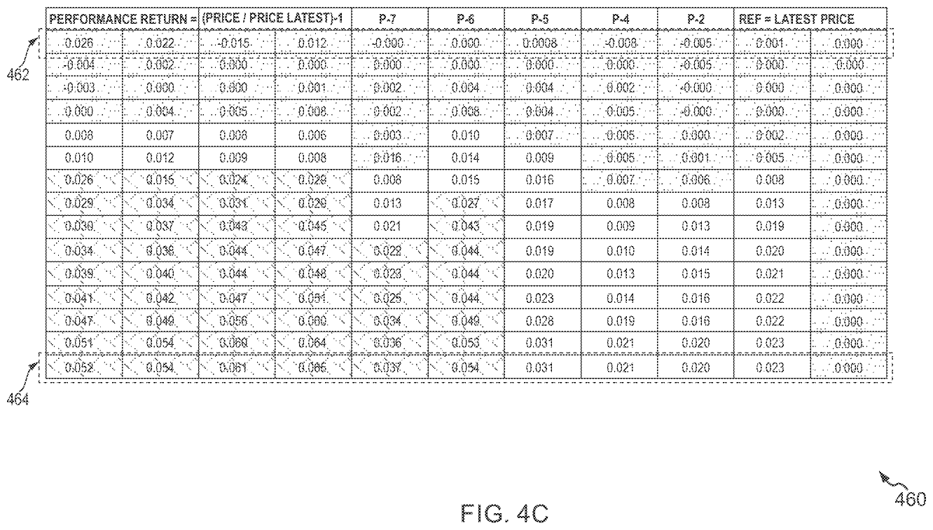

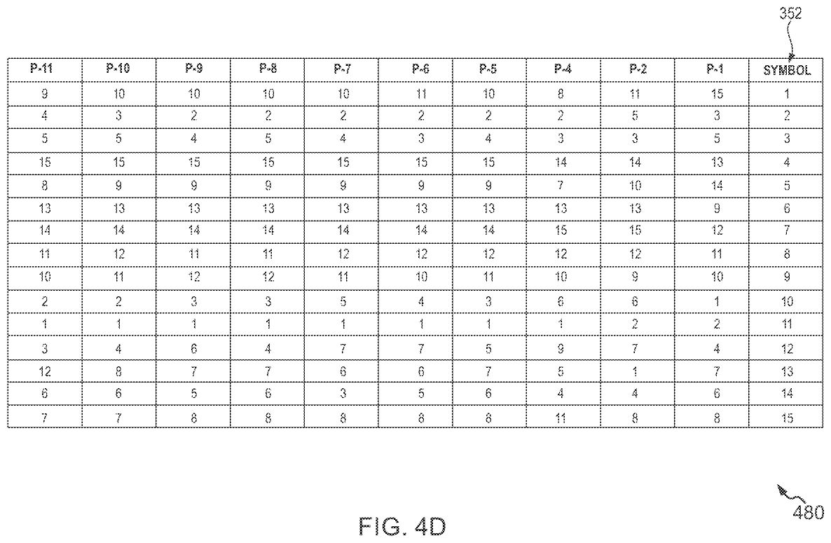

The baseline financial asset may be a US$1 value or any symbol of the multiple symbols that are traded in the stock market 308. For instance, when the baseline financial asset is US$1, then the baseline performance return percentage corresponds to 0 percent (%) as the value of US$1 remains the same for the predefined time interval such as for the past twelve years. Thus, the baseline corresponds to a symbol having the performance return percentage as 0%. In another instance, when the baseline financial asset is a symbol 302b, which is considered a market index, then the baseline performance return percentage is calculated based on the stock quotes of the symbol 302b during each period for the past twelve years. In such an instance, for the baseline to be corresponding to the performance return percentage as 0%, a predefined operation may have to be performed. The predefined operation is explained further with an example and with reference to FIGS. 4A-4D for the baseline financial asset being the symbol 302b.

In some embodiments, the predefined operation includes a subtraction operation. Therefore, the server system 102 may be configured to perform the subtraction operation on the baseline performance return percentage corresponding to the baseline financial asset and the performance return percentage of each financial asset at each period.

Furthermore, the list of performance return percentages 314 may have to be sorted to observe a pattern in which the performance return percentages for the symbols 302a-302c, 304a-304c, and 306a-306c have varied in comparison to the baseline, with time over the predefined time interval such as for past twelve years. The pattern in the variation of the performance return percentages with time may assist the users to predict future market behavior of the symbols so that the users can decide whether to buy or sell the symbols that are made available for buying or selling in the stock market 308 to make a profit. Thus, the sorting module 224 may be configured to generate a sorted list of performance return percentages 316 by sorting values corresponding to the performance return percentage for each symbol 302a-302c. 304a-304c, and 306a-306c within each period in a predefined order. The predefined order may include from a minimum negative value to a maximum positive value of the performance return percentages. An instance of the sorted list of performance return percentages that are normalized with respect to unity is shown in FIG. 3D.

Upon generating the sorted list of performance return percentages 316, a rank of each financial asset during each period in comparison to all the financial assets that are traded in the stock market 308, for the predefined time interval may have to be determined. Thus, the server system 102 is further configured to determine a position of each of the plurality of financial assets within each period by allocating a rank to each investment quote within the corresponding period, based at least on, the sorted list of performance return percentages 316. Thus, the server system 102 determines the position of each financial asset such as each stock by ranking via the ranking module 226. The ranking module 226 generates a ranked list of stocks 318 upon allocating a rank to each stock in the stock market 308.

In some embodiments, a symbol with the smallest or most negative value for the performance return percentage may be ranked first, as the investment quote for the symbol might have increased from its older value. Further, when the corresponding symbol may be chosen by a user for selling, then the user would be in profit. On the other hand, a symbol with a largest or most positive value for the performance return percentage may be ranked last, as the investment quote for the symbol might have reduced from its older value. Further, when the corresponding symbol may be chosen for selling, then the user would be at loss. Thus, the user may have to wait for the investment quote corresponding to that particular symbol to increase from an older value for the user to be able to make a profit. Therefore, based on the ranking allocated to each symbol during each period for the predefined interval, it will be easy for the users to decide on which of the symbols to invest, buy, or sell. An instance of the ranking allocated to the sorted list of performance return percentages 316 along with other symbols that are traded in the stock market 308 is explained in detail in further parts of the description with reference to FIG. 3E.

Upon ranking each symbol during each period for the predefined time interval, a visual representation 320 indicating the behavior of each symbol in terms of performance return percentage and ranking may have to be generated. Thus, the server system 102 is configured to facilitate the generation of the visual representation 320 for analyzing a market trend of the plurality of financial assets, based, at least on, the affixed baseline for the market performance index. The visual representation 320 includes contour areas indicating a variation of one or more performance-range zones for the plurality of financial assets with time, and financial asset lines indicating a change in the rank of the plurality of financial assets with time.

In some embodiments, the visual representation 320 includes a live interactive topological chart that plots a variation of three variables with respect to each other. The three variables may include time, rank, and performance return percentage. In an instance, the visual representation resembles a topological graph having the summit, the baseline, and the valley. Initially, the server system 102 generates a canvas showing a plotting of the variation in the sorted list of performance return percentages 316 via the visual representation generation module 228. The canvas is provided with one or more patterns, one or more colors, or the like for differentiating different ranges of the performance return percentages. For instance, a performance return percentage range of about 0% to about 10% is colored green, 10% to about 20% is colored darker green, 20% to about 30% back to green or darker green, and so on. In another instance, the different ranges of the performance return percentages such as 0%-10%, 10%-20%, 20%-30%, so on are alternatively colored green and white, green-white-darker green, and the like. Further, contours are formed at boundaries where two different colors meet on the visual representation 320 as shown in the FIG. 3A.

Further, the rank allocated to each symbol is also plotted on the visual representation 320, and the points corresponding to the same symbol at consecutive time period are joined to form a financial asset line. Thus, multiple financial asset lines may be generated for each symbol. Thus, the investment portfolios 302, 304, and 306 are plotted on the chart, and hence the performance return percentages corresponding to the investment portfolios 302, 304, and 306 may be compared with total market performance. A detailed explanation of an interpretation of the financial asset lines on the canvas is further provided with reference to FIG. 3E.

In addition, the server system 102 may further include a data revision module 322. The data revision module 322 may be configured to revise the generated visual representation 320 with live data feed and new time periods when the stock market 308 is open for trading, upon receiving the live data feed. For instance, for the data revision module 322 to be able to revise the visual representation 320, the data revision module 322 may be configured for scheduling event timer to perform multiple intermediate steps. Referring to FIGS. 3B-3E, the multiple intermediate steps may include adding the latest price values to a tabular representation 350, recalculating performance return percentages for each symbol for updating a tabular representation 360, updating a tabular representation 370, re-generating the canvas and contours in the visual representation 320 based on the updating of the tabular representation 370, recalculating the ranks for each symbol and updating a tabular representation 380, and drawing the financial asset lines on the visual representation 320.

However, in a non-limiting example, when there is no iteration, that is, during an idle state, the data revision module 322 may be configured to highlight each of the financial asset lines on the visual representation 320 by making the financial asset lines, for instance, bold and display relevant information in a display panel 395 as shown in FIG. 3F, at a predefined time interval. The predefined time interval may be in terms of a few seconds. Thus, each financial asset line is highlighted in rotation without any interaction with the visual representation 320, and a user may see this rotation of highlighting of the financial asset lines from a distance view.

Furthermore, in another non-limiting example, the financial asset lines may not appear on a screen displaying the visual representation 320, unless a pointer is made to hover on the visual representation 320. Thus, the server system 102 may further include an interaction enablement module 324. The interaction enablement module 324 may be configured to facilitate the pointer to interact with the visual representation on a user interface (UI) of the user device (e.g., the user device 104a) having the portfolio market trend analysis application 116 installed, by hovering over the visual representation 320. For instance, when the pointer hovers on the visual representation 320, a symbol with a rank, time, and performance return percentage gets highlighted. Further, the steps implemented by the interaction enablement module 324 are as follows:
1. Setup event notification to trigger mouse events.
2. When the mouse hovers and stops on the visual representation (e.g., a chart), return X and Y coordinates of the mouse on a screen of the user device, inside of the chart, without any click of the mouse required.
3. From the X and Y coordinates of the mouse, transform screen coordinates to Rank and Time coordinates using known scales a transform ratio of screen to chart.
4. Lookup in the database 108 about which symbol has that specific Rank at that specific time.
5. Draw that specific symbol to reveal its price line (or financial asset line) and print a name of the symbol for identification and deciding to buy or short the symbol.
6. When the user moves the mouse from a current location, remove the price line.
7. When the mouse stops at a new location, this triggers mouse coordinates event and repeats from the step 2 above.

Furthermore, the server system 102 may further include a notification management module 326. The notification management module 326 may be configured to append one or more anchors to the generated visual representation 320 to trigger event notifications when at least one of the plurality of financial assets satisfies predefined criteria associated with the rank. The predefined criteria associated with the rank may include triggering the event notification when at least one of the financial assets crosses above or below a preset rank value at any time or a predefined time range.

Moreover, for the notification management module 326 to be able to append the one or more anchors on the chart, the notification management module 326 enables the user to drag a marker via the mouse on the canvas to set rank limits at specific parts of the canvas. Further, the notification management module 326 may be configured to determine whether at least one of the plurality of financial assets matches the predefined criteria, by performing one of: refreshing a predefined timer and representing the financial asset lines on the visual representation 320. The notification management module 326 may further be configured to, upon determining that at least one of the plurality of financial assets matched with the predefined criteria, trigger the event notifications on the user device 104a based, at least on, the one or more anchors appended on the visual representation 320. Further, the visual representation 320 is further explained in detail with reference to FIG. 3F.

FIG. 3B is the tabular representation 350 of an example set of the historic investment data aggregated by the server system 102 via the aggregator 220, in accordance with an embodiment of the present disclosure. For instance, the server system 102 aggregates the historic investment data including the stock quotes illustrated in FIG. 3B for symbols 1-15 shown in a symbols column 352 for time periods P-1 (one year ago), P-2 (two years back), . . . . P-11 (11 years back), and for the latest time period (the current year) (also termed as ‘latest time’) 356. A first row 354 in the tabular representation 350 is corresponding to a value of United States dollar (US$) 1 for all the past 12 years, which is constantly US$1 with no change in its value. Thus, the symbol 1 corresponds to a quote of US$1. In an example embodiment, the historic investment includes the symbols 2-10 are substantially similar to the symbols 302a-302c, 304a-304c, and 306a-306c.

Further, in an embodiment, the symbol 1 with a quote of US$1 refers to the baseline financial asset as mentioned above, which is used for affixing the baseline for the market performance index.

FIG. 3C is the tabular representation 360 of performance return percentages calculated for the example set of the historic investment data presented in FIG. 3B by the server system 102 via the performance return calculation module 222, in accordance with an embodiment of the present disclosure. The performance return calculation module 222 further calculates the performance return percentage with reference to a predefined reference threshold of each symbol 2-10, at each period P-1 to P-11 and a latest time period as shown in FIG. 3C. In an embodiment, the symbols 2-10 are substantially similar to the symbols 302a-302c, 304a-304c, and 306a-306c respectively.

Further, for calculating the performance return percentage the following equation may have to be used:

$$Performance return percent ( \% ) = ( ( \frac{Current stock quote}{Predefined reference threshold} ) - 1 ) * 100 \qquad ( 1 )$$

For instance, the predefined reference threshold includes the latest stock quote for each symbol. Thus, the equation changes as follows:

$$Performance return percent ( \% ) = ( ( \frac{Current stock quote}{Latest stock quote} ) - 1 ) * 100 \qquad ( 2 )$$

Further, from the tabular representation 350, consider a stock quote corresponding to a period P-10 and the symbol 2, i.e., US$360.02. For this value of the symbol 2 and the latest stock quote of US$374.29 (form the tabular representation 350), a performance return percentage is calculated by the performance return calculation module 222 using the equation (2), i.e.,

$$Performance return percent ( \% ) = ( ( \frac{360.02}{374.29} ) - 1 ) * 100 = - 3.813 \%$$

The performance return percentage of −3.813% is updated in the tabular representation 360 as shown in FIG. 3C, by normalizing the value with respect to unity. Further, other values of the performance return percentages may also be calculated by using the above-mentioned equation (1) or (2) and normalized with respect to unity for updating in the tabular representation 360.

Further, for the symbol 1 which has values of US$1, the performance return percentage is calculated using the equation (1) or (2), generating the performance return percentage to be 0% which corresponds to the baseline performance return percentage, and hence can be directly considered as the baseline 362 for the market trend. This is because, the subtraction of the baseline performance return percentage which is 0% from the performance return percentage of each financial asset at each period results in the same set of values for the symbols as shown in FIG. 3C.

FIG. 3D is a tabular representation 370 of the sorted list of performance return percentages 316 showing a pattern indicating variation in the performance return percentages with time and the baseline 362 being a variation of a performance return percentage corresponding to a US$1 with time, in accordance with an embodiment of the present disclosure. The sorted list of performance return percentages 316 are arranged in the predefined order during each period. A first row 372 indicates the smallest performance return percentages for each symbol, during each consecutive period. Similarly, a row 374 indicates the highest performance return percentages for each symbol, during each consecutive period. Further, values in the tabular representation 370 are also normalized with respect to unity.

Further, in an embodiment, as shown in the tabular representation 370, each value in the sorted list of performance return percentages 316 is allocated with a predefined pattern with a predefined intensity with reference to a baseline value (0%). The predefined intensity of the predefined pattern is dependent on how far each value is, in comparison to the baseline value (0%) in the tabular representation is 370 of the sorted list of performance return percentages 316. Thus, as the value moves away from the baseline value (0%), the predefined intensity of the predefined pattern increases. In case, the value is moving below the baseline value (0%), towards becoming a more negative value, a first pattern may be used whose predefined intensity increases. In case, the value is moving above the baseline value (0%), towards becoming a more positive value, a second pattern may be the user whose predefined intensity increases. For instance, the predefined pattern such as the first pattern and the second pattern may be a lines pattern, a dotted pattern, a shaded pattern, or the like, with the first pattern being different from the second pattern.

In another embodiment, each value in the sorted list of performance return percentages 316 is allocated with a predefined color with a predefined intensity with reference to the baseline value (0%), in a way similar to the predefined pattern as explained in the above paragraph. However, the values moving below the baseline value (0%), towards becoming more negative value may have a first color, and the values moving above the baseline value (0%), towards becoming more positive value may have a second color. For instance, the predefined color such as the first color and the second color may include red, green, blue, or the like, with the first color being different from the second color.

FIG. 3E is the tabular representation 380 indicating ranks allocated to symbols enlisted in FIG. 3B, based on the sorted list of the performance return percentages 316, in accordance with an embodiment of the present disclosure. The symbol column 352 shows the symbols from 1-15 each allocated with a rank between 1 to 15 during each period for the past twelve years as shown in FIG. 3E. Consider a first column, which is a column showing ranks for the symbols during the period P-11 (11 years back). Further, since in the sorted list of performance return percentages 316 as shown in FIG. 3D, during the period P-11, the symbol 11 is placed at a first position in the column, and thus the rank allocated to the symbol 11 during the period P-11 is ‘1’. Similarly, based on the positioning of the investment quotes corresponding to the symbols arranged in the sorted list of performance return percentages 316, the ranking module 226 allocated corresponding ranks to the symbols 1-15 during each period, as shown in FIG. 3E.

FIG. 3F is a user interface (UI) 384 displaying a chart 385 that assists a user in analyzing a market trend of the example investment portfolios that are traded in the stock market 308, in accordance with an embodiment of the present disclosure. The chart 385 is substantially similar to the visual representation 320 of FIG. 3A. The chart 385 corresponds to a live interactive topological chart with X-axis representing ‘time’, Y-axis representing ‘rank’, and Z-axis representing performance return percentages, X-Z plane indicating a valley and a summit corresponding to a bottom portion of the X-Z plane and a top portion of the X-Z plane respectively.

The chart 385 includes contour areas indicating a variation of one or more performance-range zones for the plurality of financial assets with time. The contour areas thus form a canvas having valleys and summits indicating the one or more performance-range zones, thereby providing a canvas background 386 to the chart 385. For example, the one or more performance-range zones include 0%-10%, 10%-20%, 20%-30%, and the like. Further, boundaries at which the contour areas meet form contour lines as shown in FIG. 3F.

Furthermore, the chart 385 also includes financial asset lines 387 indicating change in the rank of the plurality of financial assets with time. Moreover, when the financial asset lines 387 cross each contour line may indicate +Z % raise in the performance return percentage of the corresponding plurality of financial assets. In addition to the financial asset lines 387, the chart 385 also includes a dotted curve referred to as a baseline curve 388 indicating a variation in the baseline performance return percentage which corresponds to 0% as the value of US$1 remains the same for the predefined time interval such as the past twelve years. The baseline curve 388 never crosses the contour lines as its value is always 0%. Thus, in an embodiment, analyzing the market trend of the plurality of financial assets, based, at least on, the affixed baseline for the market performance index may include determining one of the financial asset lines 387 corresponding to the financial assets 302a-302c is crossing the contour lines or the contour areas, the financial asset lines 387 are above or below the baseline curve 388. Further, Upon analyzing the market trend, a performance of an investment portfolio (e.g., the investment portfolio 302) may be analyzed.

For instance, when the financial asset lines 387 are crossing contour lines from the bottom to the top, then the investment portfolio 302 is trending up. Further, when the financial asset lines 387 are crossing the contour lines from the top to the bottom then it is trending down. Furthermore, when the financial asset lines 387 are within one of the contour areas and not crossing the contour lines, then the value of the performance of the investment portfolio 302 is going sideways during that time. Moreover, when financial asset lines 387 are parallel to the baseline curve 388 then the investment portfolio 302 is low in stock volatility. Also, the baseline curve shows where the majority of the symbols are located on the chart, for example, checking if the symbols are doing better or worse than the baseline curve 388.

In some embodiment, the one or more anchors such as anchors 389a and 389b and anchors 390a and 390b. For instance, the one or more anchors may be dynamic anchors or fixed anchors. In another instance, the one or more anchors may include at least one of relative performance anchors, a filter fixed anchor, and a notification filter anchor. Further, the relative performance anchors are a clear representation of key, known, or tracked assets to compare the relative performance which can be determined, and specified clearly on the chart 385. The relative performance anchors may include a relative performance anchor 1, wherein the relative performance anchor 1 may be a fixed value of US$1 which is shown in the chart 385 as the baseline curve 388 of 0% change over time. The relative performance anchors may further include a relative performance anchor 2, the relative performance anchor 2 may be an index of a specific market, which is usually an average of the total symbols of the middle of the market and the chart 384.

In an embodiment, the filter fixed anchor is shown in the chart 385 by the one or more anchors 389a and 389b and the anchors 390a and 390b. The filter fixed anchors may be anchors that are placed at specific locations on the chart 385. For example, the filter fixed anchors are appended to the chart 385 for building a dynamic watch list of the top 70%-90% rank at any period of time. Thus, the anchors 389a and 389b may be positioned at rank 70 and rank 90 at any time period. In another example, the filter fixed anchors 389a and 389b are appended on the chart 385 at time 1 and for rank 70-95 as shown in FIG. 3F. Similarly, the filter fixed anchors 390a and 390b are appended on the chart 385 at time 2 for rank 50-85 as shown in FIG. 3F. Further, the notification filter anchor may be used for performing one or more actions such as an alarm, a notification, a sell signal, and the like, when live performance crosses a preset threshold. For example, if the price reaches 30% from the top at time period X1 then a trigger notification is generated. In another example, if ever the rank of the stock reached 10% from the bottom then the trigger notification is generated.

As shown in FIG. 3F, a dotted vertical line 391 indicating a date 2022-12-19 on the X-Axis. The date is shown on a bottom of the chart 385, wherein X-axis is a time axis showing the date at the bottom and where the mouse is. Only when the mouse is over the chart 385, the date shows up on the timeline below the mouse pointer.

Further, the UI 384 includes a window ‘Position (5)’ 392, which displays a list of stocks owned or of interest that is highlighted and tracked on the chart 385. This list has five positions in CDE, FGH, WXY, QRS, and LMN stock. For example, if a color was used for indicating a feature of the chart, then these four symbols may be in green so they can represent to be owned and bought by the user. Each symbol is followed with a word ‘close’ which is indicating the user to sell the stock and close the position. The symbol color can be red, which may indicate an open short position for the stock.

Further, a window ‘filters (4)’ 393 is a dynamic filtered list of stocks of interest that meet a criterion of passing by four circles as shown temporarily on the chart 385. This list has 18 stocks (only the first 4 symbols are shown) of interest and for potential trading, the companies' symbols as they are listed. Clicking on “LONG” word is to trigger a buy long open position, and clicking on the “SHORT” word triggers a short open position. Further, in this scenario if color is used for indicating certain features of the UI 384, then the word “LONG” may appear in green and the word “SHORT” may appear in red.

Moreover, when the mouse is hovered over the stocks in the window ‘Position (5)’ 392, or the window ‘filters (4)’ 393, the chart 385 displays the financial asset lines 387 corresponding to the corresponding stocks along with relevant information being displayed in the display panel 395. In this scenario, the relevant information is displayed without receiving any clicks of the mouse from the user. Further, when the mouse is hovered away from the window ‘Position (5)’ 392, or the window ‘filters (4)’ 393, then the rotation of highlighting of the financial asset lines 387 at the predefined time interval is resumed by the data revision module 322.

Further, on a top left corner of the UI 384, one or more drop-down menus 394 are positioned such as Market (Fixed Income). This drop-down menu is for selecting multiple different Markets for investing. The market may be a similar or a diverse holding, stocks, bonds, mutual funds, Treasuries, commodities, crypto, or any tradable on the open market with continuous trading.

Furthermore, on a top panel of the UI 384, just above the chart 385, a display panel 395 displays a term ‘AVGO: BROADCOM.IN’ that refers to a stock name or a symbol name that may correspond to a name of a corporate company. Thus, this portion of the UI for showing the name of the symbol.

Moreover, the UI 384 displays features 396, 397, and 398 such as day, date, Day+, Day−, today, toggle switch, and play button which are provided for time travel and play simulation and live practice of real market information.

In addition, on a top right corner of the UI 384, just above the chart 385, displays information 399 corresponding to paper trading live market data and trading simulation and practice such as cash, array length, market value, total cost, and the like.

FIG. 4A is a tabular representation 400 of performance return percentages calculated for the example set of the historic investment data presented in FIG. 3B, highlighting a baseline 402 that is shifted from the variation of a performance return percentage corresponding to a US$ 1 with time to a variation of a performance return percentage for a preferred index symbol, in accordance with an embodiment of the present disclosure. From the tabular representation 350, the symbol 2 having values corresponding to stock quotes around US$370 during consecutive periods is considered as the preferred index symbol. The preferred index symbol may be used for adjusting the stock quotes for each symbol 1-15 during each period.

Further, the performance return percentages may be calculated for each symbol by considering the predefined reference threshold being a latest stock quote for each symbol. Thus, the equation 2 is used for generating the tabular representation 400. However, the tabular representation 400 represents values corresponding to the performance return percentages that are normalized with respect to unity. Furthermore, in the tabular representation 400, a first row 404 is the symbol 1 which has values for the performance return percentage calculated as US$1, which corresponds to 0%. However, a baseline financial asset considered in this embodiment is the symbol 2. Thus, the server system 102 may perform a step of affixing the baseline 402 for the market performance index by subtracting a baseline performance return percentage corresponding to the baseline financial asset, from the performance return percentage of each financial asset at each period. The server system 102 may perform this step via the performance return calculation module 222.

For instance, consider the baseline performance return percentage of the baseline financial asset, which is the symbol 2, during the period P-11. i.e., −3.072%(−0.03072 in the tabular representation 370). Subtracting this value from the value in the first row will generate a value of 3.072%. However, when the value-3.072% is subtracted from the value in the second row, then the result will be 0% which corresponds to the baseline performance return percentage. Therefore, the second row is considered to be the baseline 402 for the market trend. Moreover, this step is repeated for each symbol during each period, thereby generating a tabular representation 450 as shown in FIG. 4B. Further, the values in the tabular representation 450 also represents values that are normalized with respect to unity.

FIG. 4B is the tabular representation 450 of the performance return percentages calculated for the example set of the historic investment data presented in FIG. 3B, after performing the step of shifting the baseline 402, in accordance with an embodiment of the present disclosure. From the tabular representation 450, it can be seen that all the values of the performance return percentages during each period have changed. For instance, consider from the tabular representation 400, the value during the period P-11 in a third row, i.e., −2.239%(−0.02239 in the tabular representation 450). Upon subtraction, i.e., −0.03072−(−0.02239)=0.00833. Similarly, all the values corresponding to the performance return percentages are updated as shown in FIG. 4B.

FIG. 4C is a tabular representation 460 of a sorted list of performance return percentages showing a pattern indicating variation in the performance return percentages with time and the baseline 402 of FIG. 4B, in accordance with an embodiment of the present disclosure. The sorted list of the percentages is arranged in the predefined order during each period. A first row 462 indicates the smallest performance return percentages for each symbol, during each consecutive period. Similarly, a row 464 indicates highest performance return percentages for each symbol, during each consecutive period.

Further, in an embodiment, as shown in the tabular representation 460, each value in the sorted list of performance return percentages is allocated with the predefined pattern in a way similar to how it is done for the tabular representation 370. In another embodiment, each value in the sorted list of performances is allocated with the predefined color in a way similar to how it was done for each symbol during each period.

FIG. 4D is a tabular representation 480 indicating ranks allocated to symbols enlisted in FIG. 4A, based on the sorted list of performance return percentages of FIG. 4C, in accordance with an embodiment of the present disclosure. The symbols 1-15 are allocated with a rank between 1 to 15 during each period for the past twelve years as shown in FIG. 4D. Further, the ranks are allocated to each symbol via the ranking module 226 in a way similar to how it is done in FIG. 3E. However, the order of ranking may change as the sorted list of performance return percentages has also changed.

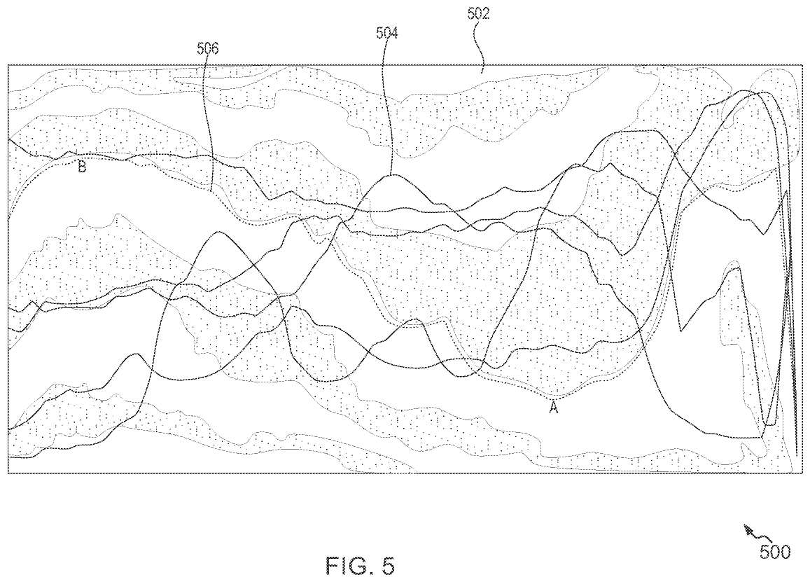

FIG. 5 is a visual representation 500 indicating a pattern associated with the variation in the sorted list of the performance return percentages with time, having two inflection points A and B, in accordance with an embodiment of the present disclosure. The visual representation 500 includes contour areas indicating the variation of the one or more performance-range zones for the plurality of financial assets with time. The contour areas thus form a canvas having valleys and summits indicating the one or more performance-range zones, thereby providing a canvas background 502 to the visual representation 500. Further, boundaries at which the contour areas meet form contour lines.

The visual representation 500 is also provided with financial asset lines 504 for a predefined count of the symbols that are participated in the predefined investment market. The performance return percentages that are plotted on the visual representation 500 may be generated with reference to the predefined reference threshold such as the latest stock quote for each symbol. In this case, a single reference is used, however, using the single reference may uncover the trending up and trending down of the market around a baseline 506 which is corresponding to the US$1 value as shown in FIG. 5. Thus, the user may notice that the market is trending downward recently (US$1 value has been going up), this latest period should still use the latest reference point from the latest prices. But before inflection point A the market was trending higher (many stocks rising above the US$1) and before it, a reference at point A may have to be used. Further, using the reference at point A provide closer and more direct information on stock volatility behavior during an uptrend. Similarly, an inflection point B indicates a start of another reference point for values older than it. Thus, the performance return calculation module 222 may be configured to calculate the performance return percentage with reference to the predefined reference threshold of each symbol at each period. The predefined reference threshold may include one of one or more investment quotes based, at least on, the presence of one or more inflection points and the average of a predefined count of the latest stock quotes. For example, the one or more inflection points may include the inflection pint A and the inflection point B.

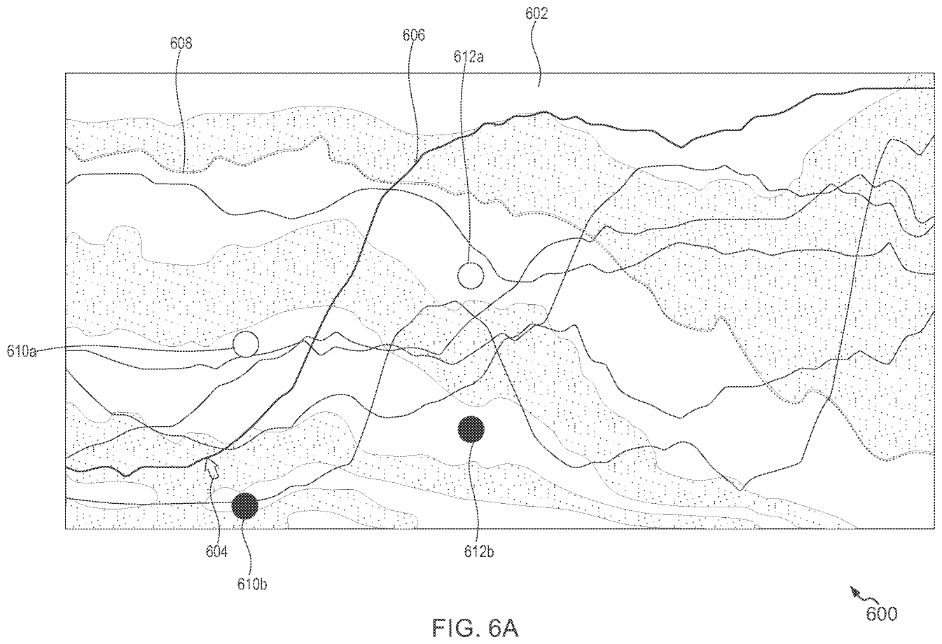

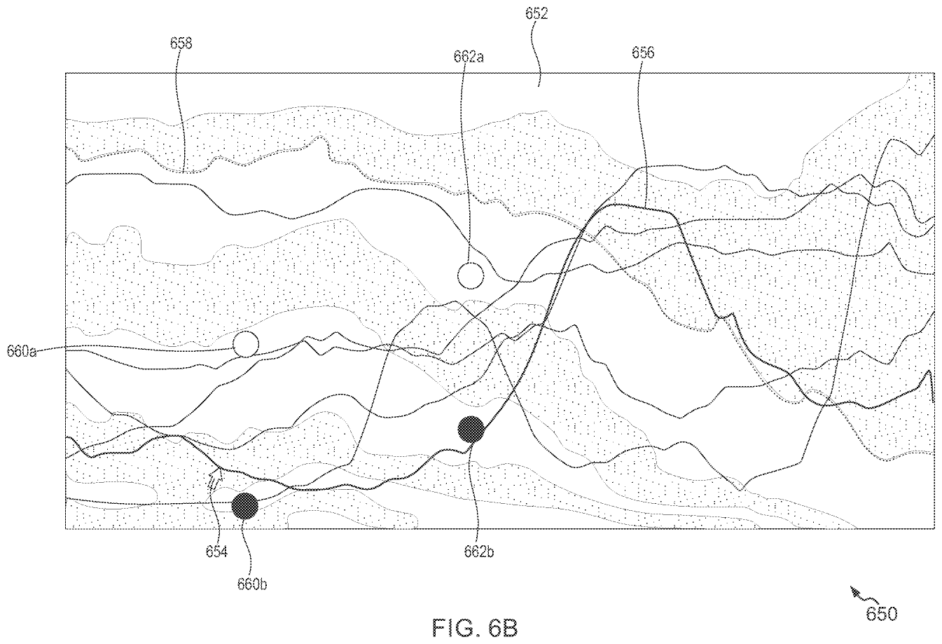

FIG. 6A is a visual representation 600 indicating a canvas background 602 associated with the variation in the sorted list of the performance return percentages with time and a pattern of stock lines, in accordance with an embodiment of the present disclosure. The FIG. 6A shows that a pointer 604 that discovers a stock line 606 under it which appears darker on the visual representation 600. The FIG. 6A also shows a baseline 608 along with anchors 610a and 610b appended to the visual representation 600 at a first timing for a first range of ranks, setting up a filter for the first range of ranks. Similarly, the FIG. 6A also shows anchors 612a and 612b appended to the visual representation 600 at a second timing for a second range of ranks, setting up a filter for the second range of ranks.

FIG. 6B is a visual representation 650 indicating a canvas background 652 associated with the variation in the sorted list of the performance return percentages with time and a pattern of stock lines, in accordance with another embodiment of the present disclosure. The FIG. 6B shows that a pointer 654 that discovers a stock line 656 under it which appears darker on the visual representation 650. The FIG. 6B also shows a baseline 658 along with anchors 660a and 660b appended to the visual representation 650 at the first timing for the first range of ranks, setting up the filter for the first range of ranks. Similarly, the FIG. 6B also shows anchors 662a and 662b appended to the visual representation 650 at the second timing for the second range of ranks, setting up the filter for the second range of ranks. Thus, the pointer 604 or 654 may always show/discover the stock line 606 or 656 under it, and a company name is shown on a top left of the visual representation 600 and 650.

During hovering the pointer 604 or 654, when a stock line is desired, the user can click on the mouse to trigger buying action, adding it to an investment portfolio of the user. Thus, the server system 102 is configured to trigger a buying action of a financial asset when a mouse corresponding to the pointer 604 or 654 is clicked by a user, wherein the pointer 654 is hovering over a financial asset line 656 of the financial asset on the visual representation 650. Further, the server system 102 responds to the click to perform the act of buying real trade or for simulation. Further, while hovering the mouse, when a stock line is for an owned stock, the user can click the mouse to sell the stock and close a held position.

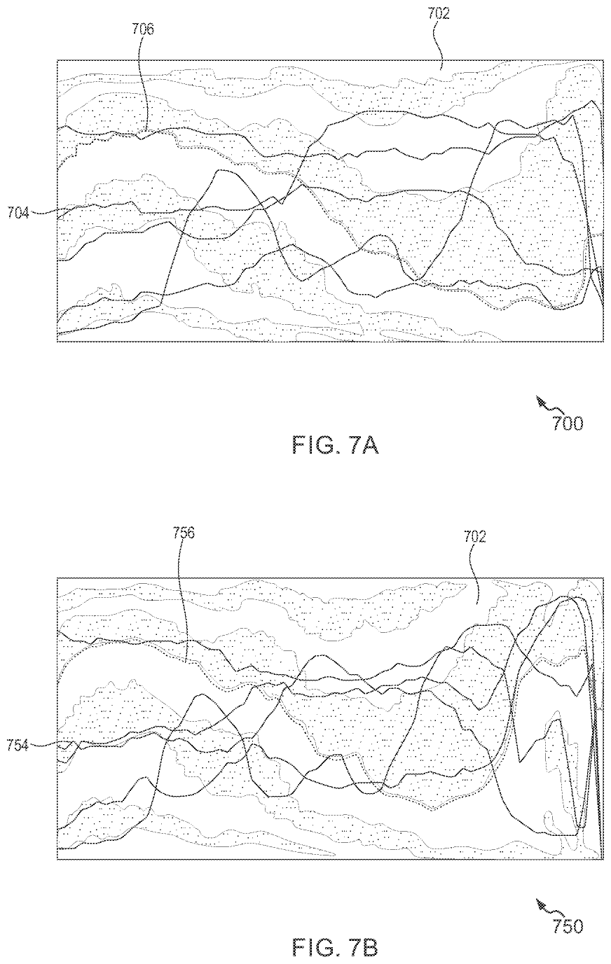

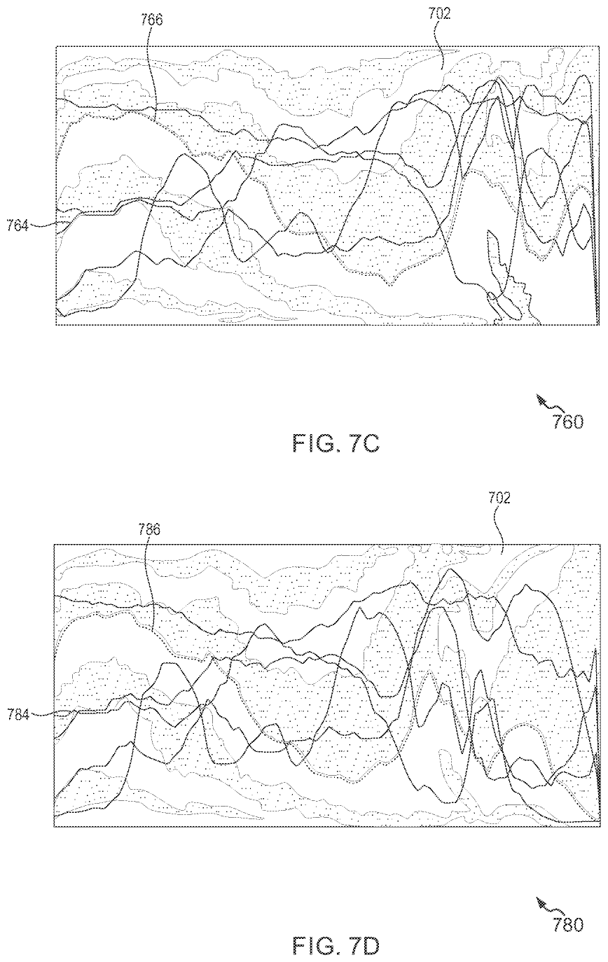

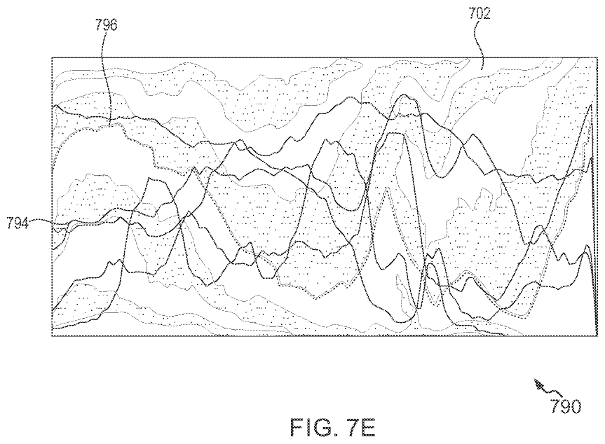

FIGS. 7A-7E collectively represents a live behavior of the investment portfolios with time represented in different visual representations 700, 750, 760, 780, and 790, in accordance with an embodiment of the present disclosure. The visual representations are numbered chronologically from 700 to 790, and the visual representation 700 represents an earliest state of the investment portfolios. Each of the visual representations 700, 750, 760, 780, and 790 are indicate a variation of one or more performance-range zones for the plurality of financial assets with time. The contour areas thus form a canvas having valleys and summits indicating the one or more performance-range zones, thereby providing a canvas background 702 to each visual representation 700, 750, 760, 780, and 790. Further, the visual representation 700 includes stock lines 704, and a baseline curve 706 as shown in FIG. 7A. Similarly, the visual representation 750 includes stock lines 754, and a baseline curve 756 as shown in FIG. 7B. Further, the visual representation 760 includes stock lines 764, and a baseline curve 766 as shown in FIG. 7C. Furthermore, the visual representation 780 includes stock lines 784, and a baseline curve 786 as shown in FIG. 7D. Lastly, the visual representation 790 includes stock lines 794, and a baseline curve 796 as shown in FIG. 7A.

As the market is updated a few minutes later, the total market is added on a right-hand side and shows various performance changes. For example, a left-hand side is distant and 50 days earlier and shows little changes.

The visual representation 750 shows that the baseline value went up and is better than 75% of the market, and 3 of 5 owned are also trending to a top right corner. The visual representation 780 shows that hours later the baseline value had dropped significantly, which means 99% of the stocks are doing better than the baseline value during that period of time, including 4 out of 5 of the owned stocks. The visual representation 790 shows the reversal in the market where the baseline value reversed upward performing better than 65% of the market, and only one out 5 stocks are outperforming the baseline value. The time frame here is very short which interests short-term investors, for long-term investors longer time periods are presented and traded against.

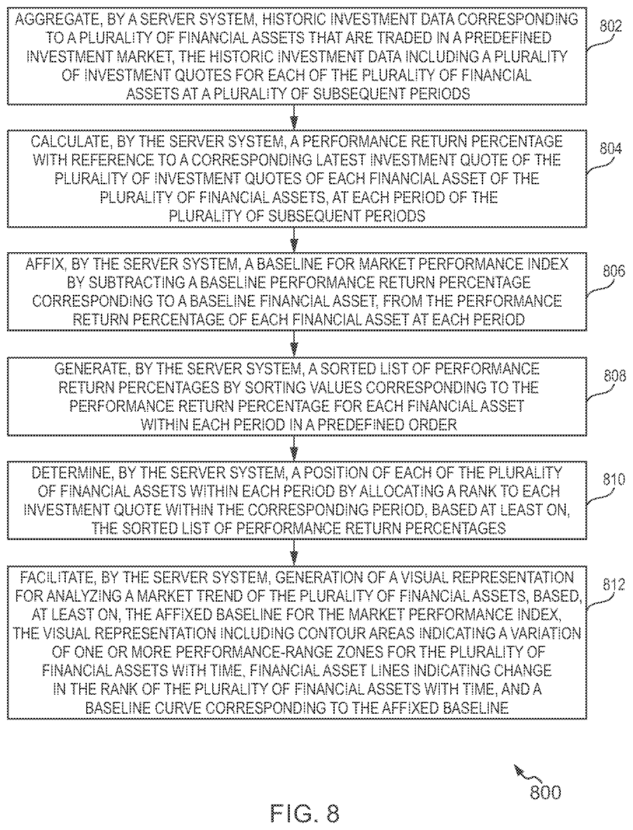

FIG. 8 is a flowchart illustrating a computer-implemented method 800 for analyzing a market trend of investment portfolios, in accordance with an embodiment of the present disclosure. The method 800 depicted in the flow diagram may be executed by, for example, at least one server system. Operations of the flow diagram of the method 800, and combinations of operations in the flow diagram of the method 800, may be implemented by, for example, hardware, firmware, a processor, circuitry, and/or a different device associated with the execution of software that includes one or more computer program instructions. The method 800 starts at operation 802.

At 802, the method 800 includes aggregating, by a server system 102, historic investment data corresponding to a plurality of financial assets that are traded in a predefined investment market. The historic investment data includes a plurality of investment quotes for each of the plurality of financial assets at a plurality of subsequent periods.

At 804, the method 800 includes calculating, by the server system 102, a performance return percentage with reference to a corresponding latest investment quote of the plurality of investment quotes of each financial asset of the plurality of financial assets, at each period of the plurality of subsequent periods.

At 806, the method 800 includes affixing, by the server system 102, a baseline for a market performance index by subtracting a baseline performance return percentage corresponding to a baseline financial asset, from the performance return percentage of each financial asset at each period.

At 808, the method 800 includes generating, by the server system 102, a sorted list of performance return percentages by sorting values corresponding to the performance return percentage for each financial asset within each period in a predefined order.

At 810, the method 800 includes determining, by the server system 102, a position of each of the plurality of financial assets within each period by allocating a rank to each investment quote within the corresponding period, based at least on, the sorted list of performance return percentages.

At 812, the method 800 includes facilitating, by the server system, generation of a visual representation for analyzing a market trend of the plurality of financial assets, based, at least on, the affixed baseline for the market performance index. The visual representation includes contour areas indicating a variation of one or more performance-range zones for the plurality of financial assets with time, financial asset lines indicating a change in the rank of the plurality of financial assets with time, and a baseline curve corresponding to the affixed baseline.

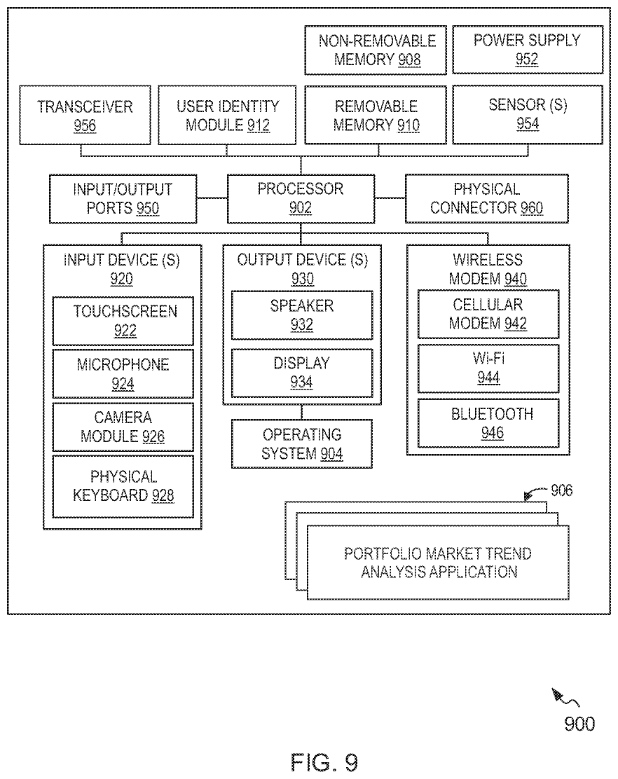

FIG. 9 shows a simplified block diagram of a user device 900 for example a mobile phone or a desktop computer capable of implementing the various embodiments of the present disclosure. For example, the user device 900 may correspond to the user devices 104a-104c of FIG. 1. The user device 900 is depicted to include one or more applications such as the portfolio market trend analysis application 906 facilitated by the server system 102. The portfolio market trend analysis application 906 can be an instance of an application downloaded from the server system 102 or a third-party server. The portfolio market trend analysis application 906 is capable of communicating with the server system 102 for creating and managing an achievement token by providing a storage that stores the achievement token in a digital wallet associated with the achiever, wherein the digital wallet resides in a public ledger.

It should be understood that the user device 900 as illustrated and hereinafter described is merely illustrative of one type of device and should not be taken to limit the scope of the embodiments. As such, it should be appreciated that at least some of the components described below in connection with the user device 900 may be optional, and thus in an example embodiment may include more, less, or different components than those described in connection with the example embodiment of the FIG. 9. As such, among other examples, the user device 900 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated user device 900 includes a controller or a processor 902 (e.g., a signal processor, microprocessor, ASIC, or other control and processing logic circuitry) for performing such tasks as signal coding, data processing, image processing, input/output processing, power control, and/or other functions. An operating system 904 controls the allocation and usage of the components of the user device 900 and supports one or more applications programs such as the portfolio market trend analysis application 906, that implements one or more of the innovative features described herein. In addition to the portfolio market trend analysis application 906, the applications may include common mobile computing applications (e.g., telephony applications, email applications, calendars, contact managers, web browsers, messaging applications) or any other computing application.

The illustrated user device 900 includes one or more memory components, for example, a non-removable memory 908 and/or removable memory 910. The non-removable memory 908 and/or the removable memory 910 may be collectively known as a database in an embodiment. The non-removable memory 908 can include RAM, ROM, flash memory, a hard disk, or other well-known memory storage technologies. The removable memory 910 can include flash memory, smart cards, or a Subscriber Identity Module (SIM). The one or more memory components can be used for storing data and/or code for running the operating system 904 and the portfolio market trend analysis application 906. The user device 900 may further include a user identity module (UIM) 912. The UIM 912 may be a memory device having a processor built in. The UIM 912 may include, for example, a subscriber identity module (SIM), a universal integrated circuit card (UICC), a universal subscriber identity module (USIM), a removable user identity module (R-UIM), or any other smart card. The UIM 912 typically stores information elements related to a mobile subscriber. The UIM 912 in form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The user device 900 can support one or more input devices 920 and one or more output devices 930. Examples of the input devices 920 may include, but are not limited to, a touch screen/a display screen 922 (e.g., capable of capturing finger tap inputs, finger gesture inputs, multi-finger tap inputs, multi-finger gesture inputs, or keystroke inputs from a virtual keyboard or keypad), a microphone 924 (e.g., capable of capturing voice input), a camera module 926 (e.g., capable of capturing still picture images and/or video images) and a physical keyboard 928. Examples of the output devices 930 may include, but are not limited to, a speaker 932 and a display 934. Other possible output devices can include piezoelectric or other haptic output devices. Some devices can serve more than one input/output function. For example, the touch screen 922 and the display 934 can be combined into a single input/output device.

A wireless modem 940 can be coupled to one or more antennas (not shown in the FIG. 9) and can support two-way communications between the processor 902 and external devices, as is well understood in the art. The wireless modem 940 is shown generically and can include, for example, a cellular modem 942 for communicating at long range with the mobile communication network, a Wi-Fi compatible modem 944 for communicating at short range with an external Bluetooth-equipped device or a local wireless data network or router, and/or a Bluetooth-compatible modem 946. The wireless modem 940 is typically configured for communication with one or more cellular networks, such as a GSM network for data and voice communications within a single cellular network, between cellular networks, or between the user device 900 and a public switched telephone network (PSTN).

The user device 900 can further include one or more input/output ports 950, a power supply 952, one or more sensors 954 for example, an accelerometer, a gyroscope, a compass, or an infrared proximity sensor for detecting the orientation or motion of the user device 900 and biometric sensors for scanning biometric identity of an authorized user, a transceiver 956 (for wirelessly transmitting analog or digital signals) and/or a physical connector 960, which can be a USB port, IEEE 994 (Fire Wire) port, and/or RS-232 port. The illustrated components are not required or all-inclusive, as any of the components shown can be deleted and other components can be added.

The disclosed method with reference to FIG. 8, or one or more operations of the method 800 may be implemented using software including computer-executable instructions stored on one or more computer-readable media (e.g., non-transitory computer-readable media, such as one or more optical media discs, volatile memory components (e.g., DRAM or SRAM)), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or in Digital Signal Processor (DSP) circuitry).

Particularly, the server system 102 and its various components such as the computer system 202 and the database 204 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or the computer to perform one or more operations. A computer-readable medium storing, embodying, or encoded with a computer program, or similar language may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method, comprising:
aggregating, by a server system, historic investment data corresponding to a plurality of financial assets that are traded in a predefined investment market, the historic investment data comprising a plurality of investment quotes for each of the plurality of financial assets at a plurality of subsequent periods;
calculating, by the server system, a performance return percentage with reference to a corresponding latest investment quote of the plurality of investment quotes of each financial asset of the plurality of financial assets, at each period of the plurality of subsequent periods;
affixing, by the server system, a baseline for a market performance index by subtracting a baseline performance return percentage corresponding to a baseline financial asset, from the performance return percentage of each financial asset at each period, wherein the baseline for the market performance index is affixed to which market behavior of the plurality of financial assets is compared for identifying a market trend of performance of the plurality of financial assets;
generating, by the server system, a sorted list of performance return percentages by sorting values corresponding to the performance return percentage for each financial asset within each period in a predefined order, wherein the predefined order is a minimum negative value of the performance return percentages to maximum positive value of the performance return percentages, wherein the values corresponding to the performance return percentage are sorted to identify a pattern in which the performance return percentages have varied in comparison to the baseline;
determining, by the server system, a position of each of the plurality of financial assets within each period by allocating a rank to each investment quote within the corresponding period, based at least on, the sorted list of performance return percentages;
facilitating, by the server system, generation of a visual representation for analyzing a market trend of the plurality of financial assets, based, at least on, the affixed baseline for the market performance index, the visual representation comprising contour areas having valleys and summits indicating a variation of one or more performance-range zones for the plurality of financial assets with time, financial asset lines indicating a change in the rank of the plurality of financial assets with time, and a baseline curve corresponding to the affixed baseline, wherein the visual representation is displayed on a screen of a user device, wherein analyzing the market trend of the plurality of financial assets, based, at least on, the affixed baseline for the market performance index comprises determining whether the financial asset lines are one of crossing the contour areas and above or below the baseline curve in the visual representation,
wherein the visual representation includes a live interactive topological chart that plots a variation of a set of variables with respect to each other, wherein the set of variables comprises time, rank, and the performance return percentage, wherein plotting a variation of the time, rank, and the performance return percentage comprises:
generating a canvas showing a plotting of a variation in the sorted list of performance return percentages in contour areas with time on the visual representation, and
plotting a rank allocated to each financial asset on the visual representation;
facilitating, by the server system, a pointer to interact with the visual representation on a user interface (UI) of the user device, by hovering the pointer over the visual representation;
upon hovering the pointer, transforming coordinates of the pointer on the screen into rank and time coordinates based on a transform ratio of the screen to the visual representation;
triggering, by the server system, a buying, selling, or exchanging action of a financial asset among the plurality of financial assets when a mouse corresponding to the pointer is clicked by a user, the pointer hovering over the financial asset line of the financial asset on the visual representation; and
performing, by the server system, the triggered action in response to the clicking on the financial asset line of the financial asset on the visual representation.

2. The computer-implemented method as claimed in claim 1, further comprising, calculating, by the server system, the performance return percentage with reference to a predefined reference threshold of each symbol at each period, the predefined reference threshold comprising one of one or more investment quotes based, at least on, presence of one or more inflection points and an average of a predefined count of latest stock quotes.

3. The computer-implemented method as claimed in claim 1, further comprising, revising, by the server system, the generated visual representation with live data feed and new time periods when the predefined investment market is open for trading, upon receiving the live data feed.

4. (canceled)

5. (canceled)

6. (canceled)

7. (canceled)

8. (canceled)

9. The computer-implemented method as claimed in claim 1, wherein the visual representation comprises a live interactive topological chart with X-axis representing ‘time’, Y-axis representing ‘rank’, and Z-axis representing performance return percentages, X-Z plane indicating a valley and a summit corresponding to a bottom portion of the X-Z plane and a top portion of the X-Z plane respectively.

10. (canceled)

11. A server system, comprising:
a memory configured to store instructions;
a communication interface; and
a processor in communication with the memory and the communication interface, the processor configured to execute the instructions stored in the memory and thereby cause the server system to perform, at least in part, to:
aggregate historic investment data corresponding to a plurality of financial assets that are traded in a predefined investment market, the historic investment data comprising a plurality of investment quotes for each of the plurality of financial assets at a plurality of subsequent periods;
calculate a performance return percentage with reference to a corresponding latest investment quote of the plurality of investment quotes of each financial asset of the plurality of financial assets, at each period of the plurality of subsequent periods;
affix a baseline for a market performance index by subtracting a baseline performance return percentage corresponding to a baseline financial asset, from the performance return percentage of each financial asset at each period, wherein the baseline for the market performance index is affixed to which market behavior of the plurality of financial assets is compared for identifying a market trend of performance of the plurality of financial assets;
generate a sorted list of performance return percentages by sorting values corresponding to the performance return percentage for each financial asset within each period in a predefined order, wherein the predefined order is a minimum negative value of the performance return percentages to maximum positive value of the performance return percentages, wherein the values corresponding to the performance return percentage are sorted to identify a pattern in which the performance return percentages have varied in comparison to the baseline;
determine a position of each of the plurality of financial assets within each period by allocating a rank to each investment quote within the corresponding period, based at least on, the sorted list of performance return percentages;
facilitate generation of a visual representation for analyzing a market trend of the plurality of financial assets, based, at least on, the affixed baseline for the market performance index, the visual representation comprising contour areas having valleys and summits indicating a variation of one or more performance-range zones for the plurality of financial assets with time, financial asset lines indicating a change in the rank of the plurality of financial assets with time, and a baseline curve corresponding to the affixed baseline, wherein the visual representation is displayed on a screen of a user device, wherein the market trend of the plurality of financial assets is analyzed based, at least on, the affixed baseline for the market performance index comprises determining whether the financial asset lines are one of crossing the contour areas and above or below the baseline curve in the visual representation,
wherein the visual representation includes a live interactive topological chart that plots a variation of a set of variables with respect to each other, wherein the set of variables comprises time, rank, and the performance return percentage, wherein, to plot a variation of the time, rank, and the performance return percentage, the processor is configured to:
generate a canvas showing a plotting of a variation in the sorted list of performance return percentages with time on the visual representation, and
plot a rank allocated to each financial asset on the visual representation;
facilitate a pointer to interact with the visual representation on a user interface (UI) of the user device, by hovering the pointer over the visual representation;
upon hovering the pointer, transform coordinates of the pointer on the screen into rank and time coordinates based on a transform ratio of the screen to the visual representation;
trigger a buying, selling, or exchanging action of a financial asset among the plurality of financial assets when a mouse corresponding to the pointer is clicked by a user, the pointer hovering over the financial asset line of the financial asset on the visual representation; and
perform the triggered action in response to the clicking on the financial asset line of the financial asset on the visual representation.

12. The server system as claimed in claim 11, further caused to calculate the performance return percentage with reference to a predefined reference threshold of each symbol at each period, the predefined reference threshold comprising one of one or more investment quotes based, at least on, presence of one or more inflection points and an average of a predefined count of latest stock quotes.

13. The server system as claimed in claim 11, further caused to revise the generated visual representation with live data feed and new time periods when the predefined investment market is open for trading, upon receiving the live data feed.

14. (canceled)

15. (canceled)

16. (canceled)

17. (canceled)

18. (canceled)

19. The server system as claimed in claim 11, wherein the visual representation comprises a live interactive topological chart with X-axis representing ‘time’, Y-axis representing ‘rank’, and Z-axis representing performance return percentages, X-Z plane indicating a valley and a summit corresponding to a bottom portion of the X-Z plane and a top portion of the X-Z plane respectively.

20. (canceled)
